(19) United States
(12) Patent Application Publication
(10) Pub. No.: US 2026/0289819 A1
(43) Pub. Date: Sep. 24, 2026

(54) IMAGING SYSTEM CALIBRATION USING STRUCTURED LIGHT

(71) Applicant: 9494-6266 QUÉBEC INC., Montreal (CA)

(72) Inventor: Raphael Morency, Montreal (CA)

(21) Appl. No.: 19/472,509

(22) PCT Filed: Apr. 4, 2024
(86) PCT No.: PCT/CA2024/050439

§ 371 Date: Oct. 3, 2025

Related U.S. Application Data
(60) Provisional application No. 63/457,020, filed on Apr. 4, 2023.

(51) Int. Cl. G06T 7/80; G06T 7/90; H04N 23/69

(52) U.S. Cl. CPC G06T 7/80; G06T 7/90; H04N 23/69; G06T 2207/10024; G06T 2207/20041; G06T 2207/30208

(57) ABSTRACT

The present disclosure relates to systems and methods for calibrating an imaging system comprising an image-forming optical system between an image display device and an image capture device. The method comprises determining a mapping function that associates a plurality of image display pixels of the image display device with a corresponding plurality of image capture pixels of the image capture device; determining an ideal image capture pixel for one or more of the plurality of image display pixels; and determining a correction function by reducing an error measure between the ideal image capture pixel and the corresponding image capture pixel of the one or more of the plurality of image display pixels, the correction function associating the one or more image capture pixels with one or more corrected image capture pixels. The method may be used to calibrate a camera of a drone, phone camera, a display, a projector, etc.

### CROSS-REFERENCE TO PREVIOUS APPLICATION

This application claims priority from U.S. provisional patent application No. 63/457,020 filed on Apr. 4, 2023, which is incorporated herein by reference in its entirety.

### TECHNICAL FIELD

The present disclosure generally relates to the correction of images from imaging systems such as cameras, displays and projectors. More specifically to computer-implemented calibration methods, apparatus and systems for implementing same, to correct geometric distortions, chromatic aberrations and provide zoom and focus corrections to improve the accuracy and reliability of the imaging results.

### BACKGROUND

The following paragraphs are provided by way of background to the present disclosure. They are not, however, an admission that anything discussed therein is prior art or part of the knowledge of persons skilled in the art.

Imaging systems such as cameras, projectors and displays often include optical elements that affect the images acquired by cameras or displayed by display and projector systems. The effect of the optical elements, such as lenses, mirrors, prisms, windows, waveguides, sensors etc., often lead to common issues such as geometric distortion, chromatic aberrations, decentering and non-uniformity in the images. These optical effects affect most, if not all, imaging systems with different degrees, and are inherent to the physics behind optics. For example, wavelength dependent refractive index of optical elements disperse light like a prism and cause light of different colors from a singular starting point to land at different positions on a camera sensor or in the eye of a user watching a display or projector image. This causes separation of colors in the images and may be perceived in visible systems as a rainbow of fringes around edges. Optical elements also deform the wavefront of an image or scene, in a way that distorts the appearance of the rendered image. Straight lines may appear to be curved, objects and perspectives to be warped. These issues are inherent to the physics of optics and are present in all imaging systems. Current cameras, displays and projectors are often approximately corrected with standard digital correction methods that apply a global model as a correction scheme. Although this approach may be able to reduce these issues to a certain degree, they are often limited to spherical lenses and high quality imaging systems as a start point. This is typically done using a simple black and white checkerboard or other static fiducials. Another approach is to increase the quality of an optical system or to add compensatory optical elements to the design. This means that manufacturers of optics still need to design using more optical elements, tighter manufacturing care and bigger form factors. The image sensor's size, orientation, and pixel arrangement also contribute to distortions.

Overall, the miniaturization and commoditization of cameras and displays has favored their proliferation in every aspect of our society but also the omnipresence of distortion. Furthermore, images captured by cameras are increasingly used for computer vision applications such as robotic, object detection, face recognition, measurement, inspection, geolocalization, autonomous driving and targeting which perform better with distortion-free images.

In this regard, various practical computer-implemented calibration methods have been previously suggested.

One of the most popular methods for correcting imaging systems involves using optical simulation software where the whole optical system is modeled, and a correction is issued from the simulation model. The issue with this simulation method is that actual optical systems rarely match the simulation and the precision required to achieve an exact match is prohibitively expensive. Optical limitations, limited by the laws of physics, also force a limit on the quality of the imaging by a device, such that it is impossible to correct these issues without having drawbacks from having an enlarged form-factor, expensive alignment, parts, and quality control required to achieve the corrections proposed by simulation.

Another popular method for cameras is the use of checkerboards, where multiple poses would be captured. Further to this method being slow and requiring the movement of the checkerboard within the field-of-view, this method suffers from low signal to noise ratio, low point recognition rates, does not account for chromatic separation of checkerboard nodes and offers a low number of reference points to compute the correction. This leads to evident downsides such as time to calibrate, wrongful assumptions of the system in question and limitations to high quality systems. It also serves to correct only a single of the present issues in an imaging system.

Optical distortion can be partly corrected by image signal processor (ISP) and post-processing software that may involve some form of artificial intelligence (AI) to improve the sharpness and color of images. These methods use general correction libraries and generative corrections that are not device specifics. Furthermore, they may produce artifacts or details by trying to create visual information where none exists.

Latest developments in calibration methods are using machine learning and artificial intelligence (AI) to adjust the images based on the features of an image, but these are generally aimed at non-scientific imaging systems. These systems deal with low density of inputs and information about the optical system and since machine learning and AI tools are limited to the density of features in their calibration method, they provide only a low to decent quality of calibration.

Other issues arise when the optical imaging systems have multiple or continuous focus or zoom positions or have variance in its manufacturing, leading to a unit-to-unit or batch to batch variable distortions and optical effects. Because all these factors are hard to predict and offer a great deal of variance system to system, the existing methods are unable to properly correct on a large scale or system basis. Existing methods are slow, lack automation or require mechanical motion, it is simple to see that existing methods are not appropriate for the future of optics. The available methods for achieving one or a few of the proposed calibrations subject in this document are primitive, time consuming, assumes a lot of erroneous modeling constraints and are not considered a general method for correcting chromatic aberrations, geometric distortion, image decentering for zoom or focus variable systems, bright and dark uniformity calibration and are generally not applicable to both camera imaging systems and display imaging systems.

In light of the above, there is a need to provide improved methods and systems implementing corrections that alleviate at least in part the deficiencies of the existing computer-implemented calibration methods.

### SUMMARY

This Summary is provided to introduce a selection of concepts in a simplified form that are further described below in the Detailed Description. This Summary is not intended to identify key aspects or essential aspects of the claimed subject matter.

Various embodiments of calibration methods and systems for an imaging system are provided according to the teachings herein.

According to an aspect of the present disclosure, there is disclosed a calibration method for an imaging system comprising an image-forming optical system between an image display device and an image capture device. The method comprising: determining a mapping function that associates a plurality of image display pixels (k,l) of the image display device with a corresponding plurality of image capture pixels (i,j) of the image capture device; using a predetermined camera model to approximate the image-forming optical system, determining an ideal image capture pixel (i′,j′) for one or more of the plurality of image display pixels (k,l); and determining a correction function by reducing an error measure between the ideal image capture pixel (i′,j′) and the corresponding image capture pixel (i,j) of the one or more of the plurality of image display pixels (k,l), the correction function associating the one or more image capture pixels (i,j) with one or more corrected image capture pixels (i_{c},j_{c}).

In some examples, determining a mapping function that associates a plurality of image display pixels (k,l) of the image display device with a corresponding plurality of image capture pixels (i,j) of the image capture device comprises: displaying a set of encoded images on the display device, the set of encoded images comprising pixel information that allows identification of image display pixels (k,l) when the encoded images are captured by the image capture device; acquiring each displayed image using the image capture device; and for each image capture pixel (i,j), identifying the corresponding image display pixel (k,l) using pixel information in the acquired images.

In some examples, determining a mapping function that associates a plurality of image display pixels (k,l) with a corresponding plurality of image capture pixels (i,j) further comprises generating the set of encoded images.

In some examples, determining an ideal image capture pixel (i′,j′) for one or more of the plurality of image display pixels (k,l) further comprises: determining ideal image display space coordinates

$${[ x , y , z ]}_{k , l}^{d}$$

of the plurality of image display pixels (k,l); and determining ideal image capture space coordinates

$${[ x , y , z ]}_{i , j}^{c}$$

of the plurality of image capture pixels (i,j), wherein the ideal image display and the ideal image capture space coordinates indicate 3D positional information of the ideal image display and the ideal image capture pixels, respectively.

In some examples, the ideal image display space coordinates

$${[ x , y , z ]}_{k , l}^{d}$$

are determined using initialized image display space coordinates

$${[ {x}_{0} , {y}_{0} , {z}_{0} ]}_{k , l}^{d}$$

given by

$${( {[ {x}_{0} , {y}_{0} , {z}_{0} ]}_{k , l}^{d} )}^{T} = [ {Δ}_{x - d} * ( l - {l}_{O} ) ; {Δ}_{y - d} * ( k - {k}_{O} ) ; 0 ]$$

with:
Δ_{x-d} being an image display pixel column width size,
Δ_{y-d} being an image display pixel row height size,
k_{O} being a display origin pixel row,
l_{O} being a display origin pixel column,
k being an image display pixel row index, and
l being an image display pixel column index;
   and the ideal image capture space coordinates

$${[ x , y , z ]}_{i , j}^{c}$$

are determined using initialized image capture space coordinates

$${[ {x}_{0} , {y}_{0} , {z}_{0} ]}_{i , j}^{c}$$

given by

$${( {[ {x}_{0} , {y}_{0} , {z}_{0} ]}_{i , j}^{c} )}^{T} = [ {Δ}_{x - c} * ( j - {j}_{O} ) ; {Δ}_{y - c} * ( i - {i}_{O} ) ; 0 ) ]$$

with:
Δ_{x-c} being an image capture pixel column width size,
Δ_{y-c} being an image capture pixel row height size,
i_{O} being a camera origin pixel row,
j_{O} being a camera origin pixel column,
i being an image capture pixel row index, and
j being an image capture pixel column index.

In some examples, the predetermined camera model is a pinhole model and determining an ideal image capture pixel (i′,j′) for one or more of the plurality of image display pixels (k,l) comprises: for each image display pixel (k,l), determining a line equation of a line that traverses a focal point of the image-forming optical system and the image display pixel (k,l); and determining an intersection between the line and an imaging plane of the image forming optical system, the intersection being the ideal image capture pixel (i′,j′).

In some examples, the predetermined camera model is a fisheye model and determining an ideal image capture pixel (i′,j′) for one or more of the plurality of image display pixels (k,l) comprises: for each image display pixel (k,l), determining a line equation of a line that traverses a focal point of the image-forming optical system and the image display pixel (k,l); and determining an intersection between the line and an imaging sphere, the intersection being the ideal image capture pixel (i′,j′).

In some examples, the correction function is limited to rotations and/or translations of the image display pixels (k,l) and/or image capture pixels (i,j) and wherein reducing the error measure is performed by varying angles of the rotations and/or distances of the translations.

In some examples, the ideal image capture pixels (i′,j′) are used as the corrected image capture pixels (i_{c},j_{c}).

In some examples, the method is used for calibrating one or more image capture device channels and/or image display channels by applying the steps of the method to the one or more color channels.

In some examples, the method is used for calibrating one or more image capture device channels, and wherein once the method is applied to a first channel, the method further comprises, for each subsequent channel of the one or more channels: determining a subsequent channel mapping function that associates a plurality of image display pixels (k,l)_{sc} of the subsequent channel with a corresponding plurality of image capture pixels (i,j)_{sc} of the subsequent channel, so that each image display pixel (k,l) is associated with a first image capture pixel (i,j)ₘ from the first channel and a second image capture pixel (i,j)_{sc} from the subsequent channel, and determining a subsequent channel correction function that is the sum between the correction function determined for the first channel and a displacement vector, the displacement vector being a vector that extends from the second image capture pixel to the first image capture pixel.

In some examples, the image calibration method further comprises: applying the correction function to one or more image capture pixels (i,j)ₘ of the first channel to obtain corrected image capture pixels (i_{c},j_{c})ₘ for the first channel; and/or applying the subsequent channel correction function to one or more image capture pixels (i,j)_{sc} of the second channel to obtain corrected image capture pixels (i_{c},j_{c})_{sc} for the second channel.

In some examples, the method is used for calibrating one or more image display device channels. Once the method is applied to a first channel, the method further comprises, for each subsequent channel of the one or more channels: determining a subsequent channel mapping function that associates a plurality of image display pixels (k,l)_{sc} of the subsequent channel with a corresponding plurality of image capture pixels (i,j)_{sc} of the subsequent channel, so that each image capture pixel is associated with a first image display pixel from the first channel and a second image display pixel from the subsequent channel, and determining a subsequent channel correction function that is the sum between the correction function determined for the first channel and a displacement vector, the displacement vector being a vector that extends from the second image display pixel to the first image display pixel.

In some examples, the image calibration method further comprises: applying the correction function to one or more image display pixels (k,l)ₘ of the first channel to obtain corrected image display pixels (k_{c},l_{c})ₘ for the first channel; and/or applying the subsequent channel correction function to one or more image display pixels (k,l)_{sc} of the second channel to obtain corrected image display pixels (k_{c},l_{c})_{sc} for the second channel.

In some examples, the method is used for calibrating a multi-parameter image capture device, and the method comprises, having corrected pixels determined for a plurality of camera multi-parameter configurations, and a multi-parameter configuration associated with a new image capture device configuration, interpolating the corrected pixels determined for the plurality of image capture device multi-parameter configurations to obtain corrected pixels associated with the new image capture device configuration.

In some examples, the image capture device multi-parameter configurations comprise: focal positions, magnification, polarization states, spectral response, and/or device geometry.

In some examples, when the method is used for calibrating a focusing image capture device, once the method is applied to a first focal position f_{p-c} of the focusing image capture device, the method further comprises, for each subsequent focal position f_{s-c}: determining a subsequent mapping function that associates a plurality of image display pixels (k,l)ₛ of the subsequent focal position with a corresponding plurality of image capture pixels (i,j)ₛ of the subsequent focal position f_{s-c}, so that each image display pixel (k,l) is associated with a first image capture pixel (i,j)ₚ from the first focal position and a second image capture pixel (i,j)ₛ from the subsequent focal position; and determining a subsequent correction function that is the sum between the correction function determined for the first focal position and a displacement vector, the displacement vector being a vector that extends from the second image capture pixel to the first image capture pixel.

In some examples, the method is used for calibrating one or more channels of a focusing image capture device. Once the method is applied to a first channel of each focal position of the focusing image capture device, the method further comprises, for each subsequent channel of each focal position: determining a subsequent channel mapping function that associates a plurality of image display pixels (k,l)_{sc} of the subsequent channel with a corresponding plurality of image capture pixels (i,j)_{sc} of the subsequent channel, so that each image display pixel (k,l) is associated with a first image capture pixel (i,j)ₘ from the first channel and a second image capture pixel (i,j)_{sc} from the subsequent channel, and determining a subsequent channel correction function that is the sum between the subsequent channel correction function determined for the first channel and a displacement vector, the displacement vector being a vector that extends from the second image capture pixel to the first image capture pixel.

In some examples, the method is used for calibrating a focusing image display device. Once the method is applied to a first focal position f_{p-d} of the focusing image display device, the method further comprises, for each subsequent focal position f_{s-d}: determining a subsequent mapping function that associates a plurality of image display pixels (k,l)ₛ of the subsequent focal position with a corresponding plurality of image capture pixels (i,j)ₛ of the subsequent focal position, so that each image capture pixel (i,j) is associated with a first image display pixel (k,l)ₚ from the first focal position and a second image display pixel (k,l)ₛ from the subsequent focal position; and determining a subsequent correction function that is the sum between the correction function determined for the first focal position and a displacement vector, the displacement vector being a vector that extends from the second image display pixel to the first image display pixel.

In some examples, the method is used for calibrating one or more channels of a focusing image display device. Once the method is applied to a first channel of each focal position of the focusing image display device, the method further comprises, for each subsequent channel of each focal position: determining a subsequent channel mapping function that associates a plurality of image display pixels (k,l)_{sc} of the subsequent channel with a corresponding plurality of image capture pixels (i,j)_{sc} of the subsequent channel, so that each image capture pixel (i,j) is associated with a first image display pixel (k,l)ₘ from the first channel and a second image display pixel (k,l)_{sc} from the subsequent channel, and determining a subsequent channel correction function that is the sum between the subsequent channel correction function determined for the first channel and a displacement vector, the displacement vector being a vector that extends from the second image display pixel to the first image display pixel.

In some examples, when the method is used for calibrating a zooming image capture device, the method is performed for each desired zoom position and the ideal image capture pixels are determined using a single camera model with varying focal positions for each zoom position.

In some examples, the method is used for calibrating one or more channels of a zooming image capture device. Once the method is performed for first channel of each desired zoom position, the method further comprises, for each subsequent channel of each desired zoom position: determining a subsequent channel mapping function that associates a plurality of image display pixels (k,l)_{sc} of the subsequent channel with a corresponding plurality of image capture pixels (i,j)_{sc} of the subsequent channel, so that each image display pixel (k,l) is associated with a first image capture pixel (i,j)ₘ from the first channel and a second image capture pixel (i,j)_{sc} from the subsequent channel, and determining a subsequent channel correction function for the subsequent channel, the subsequent channel correction function being a sum between the correction function determined for the first channel and a displacement vector, the displacement vector being a vector that extends from the second image capture pixel to the first image capture pixel.

In some examples, the plurality of pixels represents a subset of all pixels of an image, and corrected pixels of remaining image pixels are obtained by interpolating adjacent corrected pixels.

In some examples, the method is performed to calibrate the imaging system comprising the image-forming optical system between the image display device and the image capture device, the method comprising: performing the method of claim 1 to calibrate the image capture device; and/or performing the method of claim 1 to calibrate the image display device.

In some examples, the image calibration method further comprises applying the image calibration method to an image or a feed of images acquired using the image capture device.

In some examples, the image calibration method further comprises applying the image calibration method to an image or a feed of images to be displayed using the image display device.

In some examples, the image-forming optical system forms part of the image capture device.

In some examples, the image capture device is a camera.

In some examples, the image capture device is a camera forming part of a drone.

In some examples, the image capture device is a camera forming part of a targeting system of an unmanned combat aerial vehicle (UCAV).

In some examples, the image capture device is any one of a doorbell camera, a mobile phone camera, a tablet camera, a telescope, a microscope, an endoscope, and a vehicle camera.

In some examples, the image-forming optical system forms part of the image display device.

In some examples, the image display device is a projector.

In some examples, the image display device is one of a Virtual Reality (VR) headset display, and an Augmented Reality (AR) glass display.

According to another aspect of the present disclosure, there is disclosed an image calibration system for calibrating an imaging system comprising an image-forming optical system between an image display device and an image capture device, wherein the image calibration system comprises: one or more computer processors; and one or more computer readable storage media for storing computer-implemented instructions. The one or more computer processors are configured to execute the computer-implemented instructions to cause the computer system to perform a method comprising: determining a mapping function that associates a plurality of image display pixels (k,l) of the image display device with a corresponding plurality of image capture pixels (i,j) of the image capture device; using a predetermined camera model to approximate the image-forming optical system, determining an ideal image capture pixel (i′,j′) for one or more of the plurality of image display pixels (k,l); and determining a correction function by reducing an error measure between the ideal image capture pixel (i′,j′) and the corresponding image capture pixel (i,j) of the one or more of the plurality of image display pixels (k,l), the correction function associating the one or more image capture pixels (i,j) with one or more corrected image capture pixels (i_{c},j_{c}).

In some examples, the image capture device multi-parameter configurations comprise: focal positions, magnification, polarization states, spectral band, and/or device geometry.

In some examples, the image-forming optical system forms part of the image capture device.

In some examples, the image capture device is a camera.

In some examples, the image capture device is a camera forming part of a drone.

In some examples, the image capture device is a camera forming part of a targeting system of an unmanned combat aerial vehicle (UCAV).

In some examples, the image capture device is any one of a doorbell camera, a mobile phone camera, a tablet camera, a telescope, a microscope, an endoscope, and a vehicle camera.

In some examples, the image-forming optical system forms part of the image display device.

In some examples, the image display device is a projector.

In some examples, the image display device is one of a Virtual Reality (VR) headset display, and an Augmented Reality (AR) glass display.

According to another aspect of the present disclosure, there is provided a non-transitory computer program product comprising computer-implemented instructions to cause a computer system to execute the calibration method for an imaging system comprising an image-forming optical system between an image display device and an image capture device.

The calibration of an imaging device with the novel computer-implemented calibration methods is performed in an entirely digital session that works as follows: the device (camera, display or projector) executes either the capture, display or projection of a series of original images (01). These original images are device-specific and encoded with pixel coordinates to ascertain the calibration accuracy at the pixel level. The resulting device image output (RDIO) is then compared to the original images (01) to assess the pixel mislocation pattern of the device and to interpolate their corrected coordinates. The corrected pixel coordinates are stored in an instruction file.

One embodiment of the computer-implemented calibration methods, apparatus and systems is to place one or multiple devices to be calibrated simultaneously inside a darkroom-like metallic box to avoid light interference during the calibration process. Such a calibration station, comparable in size to that of a mini-fridge, boosts a lightweight design that allows for easy transport and assembly. It is versatile for laboratory, factory and field calibration.

As embodied and broadly described herein, the present disclosure relates to a computer-implemented method, an apparatus or system configured for implementing the computer-implemented method described herein, and a non-transitory medium storing computer-readable instructions which when read and executed by at least one processor of a computing device, implement the computer-implemented method described herein.

In some embodiments, the computer-implemented method of the present disclosure is suitable as a general calibration method for a display, camera, telescope, microscope, projector or optical imaging system.

In some embodiments, the computer-implemented method of the present disclosure includes in part or totality, depending on the use case, a calibration method for displays, projectors and cameras.

In some embodiments, the computer-implemented method of the present disclosure includes calibrations of images either outputted or captured from imaging devices.

In some embodiments, the computer-implemented method of the present disclosure can address one or more issues ranging from chromatic aberration (dispersion) correction, geometric distortion correction, luminance non-uniformity for brightness and darkness calibration, field-of-view parametrization, vignetting of images, to image center shift for varifocal or zoom systems.

In some embodiments, the computer-implemented method of the present disclosure enables an easy calibration of an optical imaging system. For example, the computer-implemented method of the present disclosure can remove almost all optical aberrations and issues that can occur during manufacturing, design or assembly of an optical system.

The improved speed and lack of moving parts of the computer-implemented method make it applicable on a unit by unit basis or system by system basis. In comparison, current methods for distortions and chromatic aberrations are relatively primitive.

In some embodiments, the computer-implemented method of the present disclosure corrects imaging systems as a whole, where the images of displays and cameras are corrected without the need for modeling the whole optical system, without moving the camera or the display, as well as applying for both display and camera imaging systems, with the ability to compute a calibration for each pixel of the sensor or display pixel arrays and channels if needed.

In some embodiments, the computer-implemented method of the present disclosure is able to correct for chromatic aberration, geometric distortion and other optical effects in an imaging system and presents a substantially universal method to minimize and eliminate distortions.

In some embodiments, the computer-implemented method of the present disclosure is able to correct the shifts in positions of objects and images of objects of an imaging system that occur when a change of focus happens. This presents a substantially advantageous method to eliminate distortions in variable focus systems and to correct the system at variable focus positions.

In some embodiments, the computer-implemented method of the present disclosure is able to correct the shift and decentering in positions of objects and images of objects of an imaging system that occur when a change in magnification, namely, zoom, happens. This presents a substantially advantageous method to eliminate distortions in zoom systems and to correct the system at variable magnification levels.

In some embodiments, the computer-implemented method of the present disclosure is able to correct the inhomogeneity in intensity at bright and dark fields of the imaging system and ensure homogeneous intensity within images.

In some embodiments, the computer-implemented method of the present disclosure is able to interpolate and extrapolate corrections for continuous focus positions, magnification levels or different configurations of an optical system. This presents a substantially advantageous method to generalize corrections for a continuity of system positions and configurations and thus reduces the number of calibrations required to fully describe the correction space for an imaging system.

All features of exemplary embodiments which are described in this disclosure and are not mutually exclusive can be combined with one another. Elements of one embodiment can be utilized in the other embodiments without further mention. Other aspects and features of the present invention will become apparent to those ordinarily skilled in the art upon review of the following description of specific embodiments in conjunction with the accompanying Figures.

Other features and advantages of the present disclosure will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein. A detailed description of specific exemplary embodiments is provided herein below with reference to the accompanying drawings in which:

FIG. 1 is a non-limiting flow chart illustrating steps of a calibration method for imaging displays, projectors and cameras, in accordance with an embodiment of the present disclosure;

FIG. 2 is a non-limiting illustration depicting a general strategy to correct displays and cameras using the calibration method of the present disclosure, in accordance with an embodiment of the present disclosure;

FIG. 3A is a non-limiting schematic that illustrates different configurations to fully calibrate cameras (left) and projector or display imaging systems (right), in accordance with an embodiment of the present disclosure;

FIG. 3B is a non-limiting schematic that illustrates different configurations needed to partially calibrate cameras (left) and projector or display imaging systems (right), in accordance with an embodiment of the present disclosure;

FIG. 4 is a non-limiting schematic that illustrates different stages at which imaging corrections may be implemented, in accordance with an embodiment of the present disclosure;

FIG. 5 show exemplary meshes computed for camera and/or display calibration to become reference camera and/or display, in accordance with an embodiment of the present disclosure;

FIG. 6 shows exemplary encoding of imaging for the retrieval of row, column and channel information of a display within the images of an optical imaging acquisition device, in accordance with an embodiment of the present disclosure;

FIG. 7 shows an example of encoding images used for encoding pixel position of a display device or a camera device, in accordance with an embodiment of the present disclosure;

FIG. 8 shows an ideal geometric representation of a fixed or focusable camera using a pin-hole model, in accordance with an embodiment of the present disclosure;

FIG. 9 shows an ideal geometric representation of a fisheye camera-based model, in accordance with an embodiment of the present disclosure;

FIG. 10 shows an example method 200 for calibrating a single configuration camera using a reference display, in accordance with an embodiment of the present disclosure;

FIG. 11 shows an example method 300 for calibrating a fixed display and projector using a reference camera, in accordance with an embodiment of the present disclosure;

FIG. 12A shows a representation of chromatic and non-chromatic calibration using channel matching of a camera and display pair, in accordance with an embodiment of the present disclosure;

FIG. 12B shows a representation of chromatic and non-chromatic calibration using channel matching of a camera or display and a correction matrix, in accordance with an embodiment of the present disclosure;

FIG. 13 shows an example method 400 for calibrating a focusing camera using a reference display, in accordance with an embodiment of the present disclosure;

FIG. 14 shows an example method 500 for calibrating a focusing display and projector using a reference camera, in accordance with an embodiment of the present disclosure;

FIG. 15A shows an ideal geometric representation of a zooming camera pin-hole model, in accordance with an embodiment of the present disclosure;

FIG. 15B shows an example method 600 for calibrating zooming image capture device having one or more channels, in accordance with an embodiment of the present disclosure;

FIG. 16A shows a representation of correction for a desired configuration using interpolation between multi-parameter configurations, in accordance with an embodiment of the present disclosure;

FIG. 16B shows a representation of decimated or missing pixel correction values using 2D interpolation, in accordance with an embodiment of the present disclosure;

FIG. 17 shows a representation of a reprojection fitting of a pinhole camera model and display pair, in accordance with an embodiment of the present disclosure;

FIGS. 18A-C show a drone camera calibration system, a multiple drone camera calibration system, and drone camera calibration system in a dark-room station, respectively, in accordance with an embodiment of the present disclosure;

FIGS. 19A-C show a VR headset display calibration system, a multiple VR headset display calibration system, and a VR headset display calibration system in a darkroom station, respectively, in accordance with an embodiment of the present disclosure; and

FIG. 20 shows an example calibration method for an imaging system comprising an image-forming optical system between an image display device and an image capture device, in accordance with an embodiment of the present disclosure.

In the drawings, exemplary embodiments are illustrated by way of example. It is to be expressly understood that the description and drawings are only for the purpose of illustrating certain embodiments and are an aid for understanding. They are not intended to be a definition of the limits of the invention.

### DETAILED DESCRIPTION

The present technology is explained in greater detail below. This description is not intended to be a detailed catalog of all the different ways in which the technology may be implemented, or all the features that may be added to the instant technology. For example, features illustrated with respect to one embodiment may be incorporated into other embodiments, and features illustrated with respect to a particular embodiment may be deleted from that embodiment. In addition, numerous variations and additions to the various embodiments suggested herein will be apparent to those skilled in the art considering the instant disclosure which variations and additions do not depart from the present technology. Hence, the following description is intended to illustrate some embodiments of the technology, and not to exhaustively specify all permutations, combinations, and variations thereof.

Various embodiments in accordance with the teachings herein will be described below to provide an example of at least one embodiment of the claimed subject matter. No embodiment described herein limits any claimed subject matter. The claimed subject matter is not limited to devices, systems, or methods having all of the features of any one of the devices, systems, or methods described below or to features common to multiple or all of the devices, systems, or methods described herein. It is possible that there may be a device, system, or method described herein that is not an embodiment of any claimed subject matter. Any subject matter that is described herein that is not claimed in this document may be the subject matter of another protective instrument, for example, a continuing patent application, and the applicants, inventors, or owners do not intend to abandon, disclaim, or dedicate to the public any such subject matter by its disclosure in this document.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling can have a mechanical or electrical connotation. For example, as used herein, the terms coupled or coupling can indicate that two elements or devices can be directly connected to one another or connected to one another through one or more intermediate elements or devices via an electrical signal, electrical connection, or a mechanical element depending on the particular context.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5%, or 10%, for example, if this deviation does not negate the meaning of the term it modifies.

Further, although method steps may be described (in the disclosure and/or in the claims) in a sequential order, such methods may be configured to work in alternate orders. In other words, any sequence or order of steps that may be described does not necessarily indicate a requirement that the steps be performed in that order. The steps of methods described herein may be performed in any order that is practical. Further, some steps may be performed simultaneously.

The example embodiments of the devices, systems, or methods described in accordance with the teachings herein may be implemented as a combination of hardware and software. For example, the embodiments described herein may be implemented, at least in part, by using one or more computer programs, executing on one or more programmable devices comprising at least one processing element and at least one storage element (i.e., at least one volatile memory element and at least one non-volatile memory element). The hardware may comprise input devices including one or more of a touch screen, a keyboard, a mouse, buttons, keys, sliders, and the like, as well as one or more of a display, a printer, and the like depending on the implementation of the hardware.

It should also be noted that there may be some elements that are used to implement at least part of the embodiments described herein that may be implemented via software that is written in a high-level programming language. The program code may be written in Rust, C++, C#, JavaScript, Python, or any other suitable programming language and may comprise modules or classes, as is known to those skilled in the art. Alternatively, or in addition thereto, some of these elements implemented via software may be written in assembly language, machine language, or firmware as needed. In either case, the language may be a compiled or interpreted language.

At least some of these software programs may be stored on a computer readable medium such as, but not limited to, a ROM, a magnetic disk, an optical disc, solid-state storage, a USB key, and the like that is readable by a device having a processor, an operating system, and the associated hardware and software that is necessary to implement the functionality of at least one of the embodiments described herein. The software program code, when read by the device, configures the device to operate in a new, specific, and predefined manner (e.g., as a specific-purpose computer) in order to perform at least one of the methods described herein.

At least some of the programs associated with the devices, systems, and methods of the embodiments described herein may be capable of being distributed in a computer program product comprising a computer readable medium that bears computer usable instructions, such as program code, for one or more processing units. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

As used herein, the term chromatic aberration also known as color fringing means a failure to focus all colors on the same point in an imaging system. The misalignment of color channels (red, green and blue) phenomena occurs when different wavelengths of light refract through different parts of a lens system. Thus, the color channels may not align as they reach the sensor/film or eye.

As used herein, the term geometric distortion, also known as warping, barrel distortion, pincushion distortion, etc., means a geometric misplacement of information whereby the spatial relationships between pixels in the image do not equate to the spatial relationships between corresponding points in the scene in an imaging system. Such distortion is inevitable due to the perspective projection effected by lenses. The image sensor's pixel arrangement and size can also influence its manifestation.

As used herein, the term color channel means the individual components of color information that, when combined, form a complete color image. In digital systems, an image is generally represented in terms of combinations of primary colors (red, green and blue), and each of these primary colors represents a channel. In a color digital image, each pixel is composed of combinations of these primary colors.

As used herein, the term pixel, short for picture element, means the smallest unit of a digital image or display. A pixel is an isolated dot that represents one color or one polarization state and when combined, pixels create a mosaic of colors and shapes, forming the visual content displayed on screens.

As used herein, the term structured light means the projection of a known pattern (often grids or horizontal bars) onto a scene. The way that these patterns deform when striking surfaces allows vision systems to calculate the depth and surface information of the objects in the scene, as used in structured light 3D scanners

The present inventor has designed and developed computer-implemented calibration methods for imaging displays, projectors, and cameras to correct geometric distortions, chromatic aberrations and improve the accuracy and reliability of the imaging results. The present inventor has also developed a system configured for implementing the computer-implemented method described herein, and a non-transitory medium storing computer-readable instructions which when read and executed by at least one processor of a computing device, implement the computer-implemented method described herein. By using calibration methods for imaging displays and cameras, users are able to obtain higher quality images with greater accuracy than previously achievable.

In some embodiments, the present disclosure provides an improved calibration method for imaging displays and cameras that correct typical optical distortions present in imaging systems and improves the accuracy, and quality of the imaging results.

In some embodiments, the computer-implemented method of the present disclosure relates to a method for imaging system calibration using structured light. As used herein, the term camera encompasses any suitable optical imaging system, image acquisition system or camera. Similarly, as used herein, the term display encompasses any suitable projectors, displays or image display systems.

In some embodiments, the computer-implemented method of the present disclosure encompasses the calibration and correction of displays or projector, including raster-based, scanning or regular displays, monochromatic, polychromatic, hyperspectral or filtered in wavelength. In some embodiments, the computer-implemented method of the present disclosure encompasses the calibration and correction of optical cameras, monochromatic, polychromatic, hyperspectral or filtered in wavelength or polarization. Any of those cameras or displays or projectors, may also include added image sensors and optical elements without departing from the present disclosure. This includes lenses, mirrors, mirror arrays, liquid crystal technologies, refraction-based, diffraction-based polarization-based, transmission-based, absorptive-based, reflection-based optics, nonlinear optical elements, refraction-based cells, metasurface optics, holographic optics, or bare sensors, bare display or projector systems. In a sense, as will be apparent to the reader from the teachings of the present disclosure, the computer-implemented method of the present disclosure may be used with any optical system involving a display, camera, or imaging system.

The present specification refers to reference hardware, such as reference camera or reference display. In the case of reference cameras, it is intended to describe a camera which has been calibrated using the present method. In the case of reference displays, it is intended to describe a display which has been calibrated using the present method or a flat monitor display which is considered to be of good enough tolerance in terms of flatness and pixel coordinate uniformity. As such, a typical computer monitor, or phone display may be used to calibrate cameras, depending on the optics or applications affecting the images of the cameras. This allows the method of the present disclosure to correct cameras that could be part of telescopes, optical systems or microscopes.

In some embodiments, the computer-implemented method of the present disclosure may include several steps.

In the context of the invention, channels are referring to the multiplexed signals within an image of an imaging system that may represent different spectral bands of light or polarizations. This includes color images with RGB filters, but is not limited to standard colors and can effectively be generalized to any plurality of spectral bands, as well as polarization states. This is to account for non-standard cameras, projectors and displays that may exist, such as RGB and Y, standing for yellow, displays and projectors, or devices in arbitrary polarization orientations and not limited to 0°, 45°, 90°, 135° polarization grids. This is effectively a generalized method for imaging devices with any plurality of spectral or polarization channels.

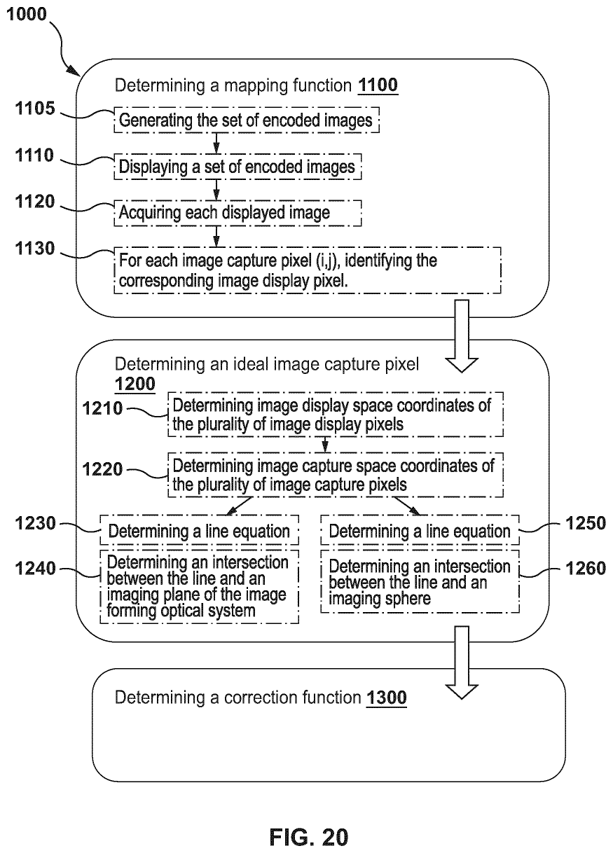

In accordance with the teachings herein and with respect to FIG. 20, there are provided various embodiments for a calibration method 1000 for an imaging system comprising an image-forming optical system between an image display device and an image capture device. The method 1000 comprises determining 1100 a mapping function that associates a plurality of image display pixels (k,l) of the image display device with a corresponding plurality of image capture pixels (i,j) of the image capture device. The method further comprises, using a predetermined camera model to approximate the image-forming optical system, determining 1200 an ideal image capture pixel (i′,j′) for one or more of the plurality of image display pixels (k,l); and determining 1300 a correction function by reducing an error measure between the ideal image capture pixel (i′,j′) and the corresponding image capture pixel (i,j) of the one or more of the plurality of image display pixels (k,l), the correction function associating the one or more image capture pixels (i,j) with one or more corrected image capture pixels (i_{c},j_{c}).

In one embodiment, the positions of the corrected image display devices pixels are given by a transformation which brings the initialized image display pixel coordinates to an ideal position for one or more of the plurality of image display pixels (k,l) wherein the initialized positions become translated using a vector \vec{T_{d}} and rotated using a rotation matrix R_{d}:

$${[ \begin{matrix}x \\ y \\ z\end{matrix} ]}_{k , l}^{d} = {{R}_{d} [ \begin{matrix}{x}_{0} \\ {y}_{0} \\ {z}_{0}\end{matrix} ]}_{k , l}^{d} + \vec{{T}_{d}}$$

In one embodiment, the positions of the corrected image capture devices pixels are given by a transformation which brings the initialized image capture pixel coordinates to an ideal position for one or more of the plurality of image capture pixels (i,j) wherein the initialized positions become translated using a vector and rotated using a rotation matrix R_{c}:

$${[ \begin{matrix}x \\ y \\ z\end{matrix} ]}_{i , j}^{c} = {{R}_{c} [ \begin{matrix}{x}_{0} \\ {y}_{0} \\ {z}_{0}\end{matrix} ]}_{i , j}^{c} + \vec{{T}_{c}}$$

Corrections are found in the form of either matrices or linear vectors. Typically, the correction data is in the form of the row correction matrix or vector, column correction matrix or vector, and optionally the channel address matrix or vector of the image of the targeted imaging system. In the case of matrices, the correction addresses in row M, column N and channel C of a correction matrix represent a new address in the corrected image. In matrix form, a specific matrix for the row new address and another for column new address exist but may also be stored within one matrix by concatenating binary numbers and converting it to a single number within the matrix. The new addresses for the rows and columns can be integers or decimal numbers, in which the latter can be computed from 2D interpolation methods like a bilinear interpolation. In the case of linear vectors, a linear vector for the rows and columns may be used to represent the new address of the linear indices within the image matrix. Similarly for the linear vectors, the rows and columns can have their binary representation concatenated to store as a single binary number.

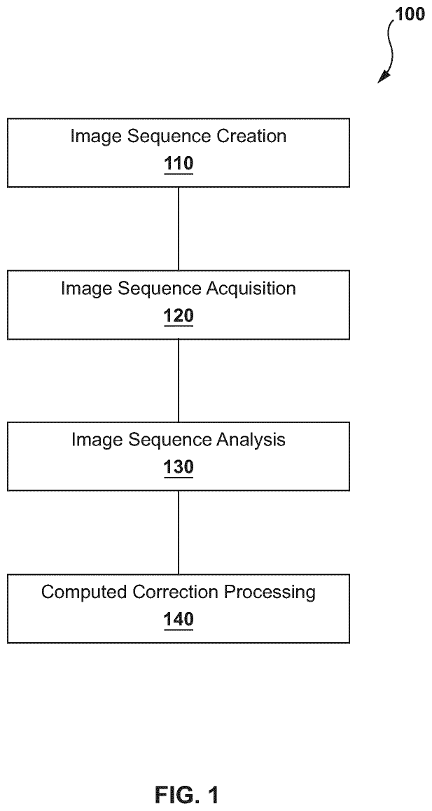

FIG. 1 shows another logical representation of the teachings of methods disclosed herein.

For example, and with respect to FIG. 1, method 100 may include steps such as image sequence creation 110, image sequence acquisition 120, image sequence analysis 130, and computed correction image processing 140. Step 110 of image sequence creation, generates image patterns that a display, calibrated or not, will display, in order to encode the positions of its pixels within images of a camera. These images are similar to the ones used in structured light 3D reconstruction systems and are used to recover the displayed images pixel information such as pixel row and column positions and numbers of display channels within a camera image. Step 120 of image sequence acquisition synchronizes the display images being shown and the camera acquisitions of those images. The sequence completes the acquisition of all the required images to compute the hardware calibrations. The sequence involves the binary encoding of all or a decimated set of pixel positions of a display, which allows the decoding within the collected images. Step 130 of image sequence analysis computes the corrections that can be applied to either a camera or a display. Step 140 applies computed correction to all further images of the camera or display being calibrated and be assumed to be corrected in the ways the user may want to correct the optical system.

The calculations performed by method 100 are further described above. For ease of understanding of the equations presented with respect to the calculations performed in accordance with method 100, bold variables refer to matrices, uppercase “R” and “C” and “ch” relate to rows, columns, and channels of matrices respectively. Lowercase “c” and “d” relate to their respective camera and display groups respectively. The letters “x”, “y” and “z” designate the Cartesian component in their respective dimensions. The subscript number “0” designate the initialized value of a variable which is later transformed to represent the optical system. The subscript letter “o” designates the assigned origin of a variable or index. The superscript “Q” designates intersection spatial coordinates. The superscript “*” designates a value that is offset by the assigned origin of that value. The superscript “′” is meant to represent an ideal image capture or display index. The “,“and”;” within a matrix or vector is meant to represent the use of another column and another row respectively. The use of square brackets “[” and “]” is used to designate a vector or matrix. The subscripts “p” and “s” are used to designate a first primary state and a subsequent state respectively. The subscripts “m” and “sc” are used to designate a first image channel and a subsequent image channel respectively. The superscript “T” is meant to designate the transpose of a vector or a matrix.

Back to method 1000, determining 1100 a mapping function that associates a plurality of image display pixels (k,l) of the image display device with a corresponding plurality of image capture pixels (i,j) of the image capture device may comprise: displaying 1110 a set of encoded images on the display device, the set of encoded images comprising pixel information that allows identification of image display pixels (k,l) when the encoded images are captured by the image capture device; acquiring 1120 each displayed image using the image capture device; and for each image capture pixel (i,j), identifying 1130 the corresponding image display pixel (k,l) using pixel information in the acquired images.

In some embodiments, determining 1100 a mapping function further comprises generating 1105 the set of encoded images.

With respect to generation 1105 of display encoded images, for a given full resolution image of a display represented as a matrix of dimensions M_{d}*N_{d}*C_{d}, let M_{d}, N_{d}, and C_{d} be equal to the number of rows, columns and channels available to be displayed respectively.

To generate the encoded images, channels may be encoded individually as layers of the three dimensional matrix of the image. The number of binary bits required to describe the number of rows and number of columns of the image allows to fully encode a channel. These numbers are n_{R} and n_{C} representing the required number of bits to encode the rows and columns respectively.

It follows that for a given number of elements “N”, the required number of bits “n” is given by: n=ceil(log(N)/log(2)).

It follows that the required number of bits for the row and column encoding are:

$${n}_{R} = ceil ( log ( {M}_{d} ) / log ( 2 ) )$$

$${n}_{C} = ceil ( log ( {N}_{d} ) / log ( 2 ) )$$

The bit string is a set of “0” and “1” in succession that can be set to represent any of the integers up to 2ⁿ. The function ceil rounds the value to the nearest greater integer. For example, for an image composed of 64 pixel rows and 128 pixel columns, the required number of bits for encoding all rows and columns are 6 and 7 respectively. The bitstring is simply the binary string representing the integer number of a specified row or column. Row 60 would therefore be assigned a direct representation of 59 as ‘111100’. In order to encode the rows and columns, 2 sets of n_{R} and n_{C} images are used. Each image has all or a decimated set of its elements encoded. To do so, the computation of all numbers in binary representation is done, and in the n images of a set, the index of the image selects the bit position. If the bit is set to “1” for a specific element, then the pixel is turned “on” and if the bit is set to “0”, then the pixel is turned “off”. For example of row 60, the row 60 of the set would be “on”, “on”, “on”, “off”, “on”, “on”. The sequence in the order of the encoded bits would therefore compose the binary number after the sequence has been displayed. The computation of the binary numbers for each row and column encoding is known for a person skilled in the art.

It is important to observe that the encoding of bits yields the same results no matter the bases, encoding schemes, coordinate representation, substitutions, encryptions or reorganization schemes applied to the order of bits throughout the encoding of the images and as such, the main differences would be potential computation efficiencies or greater signal to noise ratio in the decoding phase, which do not change the core claims of this embodiment. Furthermore, the complete resolution of the display may or may not be used. In the latter case, a decimated version of the images would be generated, where only 1 of every d_{M} rows and d_{N} columns are encoded, where d_{M} and d_{N} are the decimation integers. For such a case, the number of rows and columns to encode reduces to the nearest rounded down integer of M_{d}/d_{M} and N_{d}/d_{N} respectively or other arbitrary reduction scheme. This is to allow the calibration of contrast or resolution limited cameras or displays.

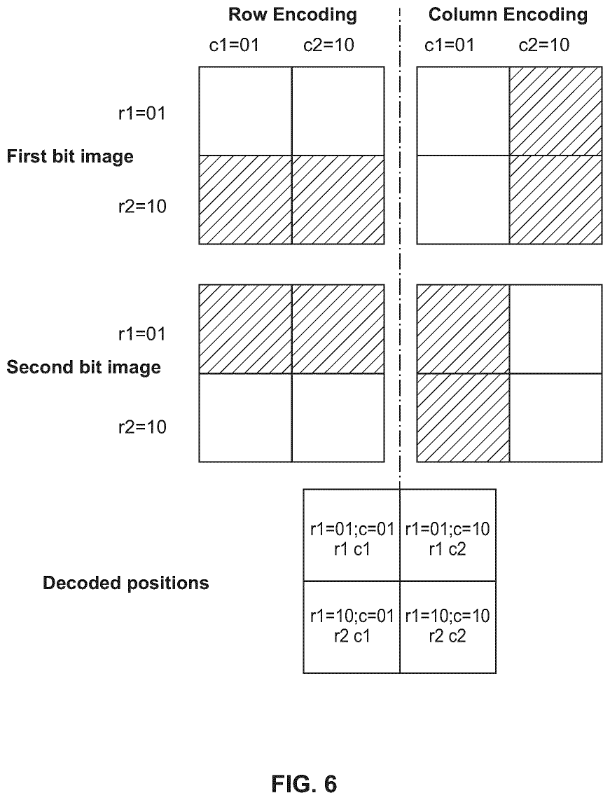

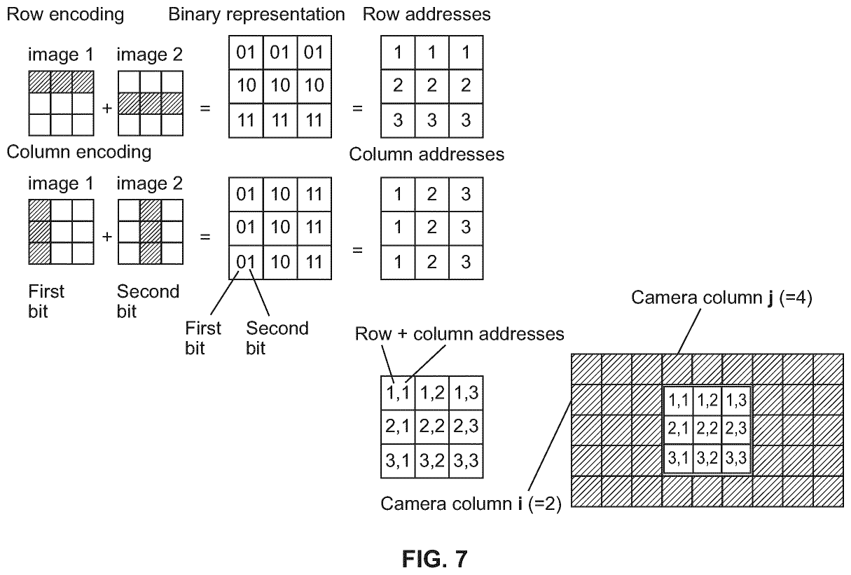

FIGS. 6 and 7 show example encoding of images for the retrieval of row, column and channel information of a display within a first and a second set of images of an optical imaging acquisition device.

FIG. 7 shows an example encoding images used for encoding pixel position of a display device or a camera device having a resolution of 9 pixels (i.e., 3 pixel rows and 3 pixel columns). As explained before, two sets of images are required to encode the rows and columns.

With respect to channel assignment between camera and display pair, each calibration in the document is composed of at least one camera and display pair. This is the minimum calibration set. The present proposed method also works on multiple cameras and display assignments, such that multiple cameras can be calibrated using a single display. Multiple displays can also be calibrated using a single camera. Any combinations of the above-mentioned groups are part of the embodiments of this document. In addition, depending on the spectral filters in use for each camera pixels or display pixels, whether reflective, transmissive, absorptive or modulated by another mechanism, a specific camera channel can be assigned to one or multiple display channels and a specific display channel can also be assigned to one or multiple camera channels. The assignments are generally determined by the combination that has the highest signal to noise ratio. For example, the blue channel of the display may be assigned to the blue channel of a camera, due to the filtering that a Bayer filter or other kinds would do. For a monochrome camera, one could choose the display color which has the highest quantum efficiency within the sensor of the camera, which yields the highest intensity in the camera image. For a monochrome display, one could choose the camera channel (if a multichannel camera) that has the most intense signal due to the selectivity of the camera filters. For example, a green display would be brightness within the green channel of a camera. If one device is monochrome or multichannel or does not possess the same number of channels as its paired device, then channels may be reused for multiple assignments. The same is true for combinations of channels assigned to single or multiple channels between paired devices. The term multichannel is employed instead of “color” because the invention is not limited to classic 3 channel displays or cameras, but also includes imaging systems that employ more or different channels than conventionally.

Now initialized reference display and camera pixel row and column addresses are generated. In this embodiment, the camera sensor and display pixel positions within the ideal pinhole model are first compute using 2 matrices of size M_{d}*N_{d} for displays and 2 matrices of size M_{c}*N_{c} for cameras. It follows that each channel of a camera or display also have such addresses along the third dimension of the matrices. These matrices are simply the row numbers and column numbers of each pixel within the array of pixels of the images. For example, a display of size 3 rows by 5 columns and 1 channel would have the following matrices:

$${E}_{R - d - 0} = [ \begin{matrix}1 & 1 & 1 & 1 & 1 \\ 2 & 2 & 2 & 2 & 2 \\ 3 & 3 & 3 & 3 & 3\end{matrix} ] {E}_{C - d - 0} = [ \begin{matrix}1 & 2 & 3 & 4 & 5 \\ 1 & 2 & 3 & 4 & 5 \\ 1 & 2 & 3 & 4 & 5\end{matrix} ]$$

where:
E_{R-d-0}: is the initial row number matrix of the display;
E_{C-d-0}: is the initial column number matrix of the display;

The general representations of these matrices are:

$${E}_{R - d - 0} = [ \begin{matrix}1 & … & 1 \\ ⋮ & ⋱ & ⋮ \\ {M}_{d} & … & {M}_{d}\end{matrix} ] ; {E}_{C - d - 0} = [ \begin{matrix}1 & … & {N}_{d} \\ ⋮ & ⋱ & ⋮ \\ 1 & … & {N}_{d}\end{matrix} ] ; and$$

$${E}_{R - c - 0} = [ \begin{matrix}1 & … & 1 \\ ⋮ & ⋱ & ⋮ \\ {M}_{c} & … & {M}_{c}\end{matrix} ] ; {E}_{C - c - 0} = [ \begin{matrix}1 & … & {N}_{c} \\ ⋮ & ⋱ & ⋮ \\ 1 & … & {N}_{c}\end{matrix} ] ;$$

where:
E_{R-c-0}: is the initial row number matrix of the camera; and
E_{C-c-0}: is the initial column number matrix of the camera;

Now, display, projector, and camera decoding is performed. In order to calibrate a display or camera, the row and column sets of encoded images of the display are displayed in a sequence, and an acquisition image is taken for each of the encoded images. The images are then filtered using a binary filter and the images are summed in each set. This sum is a binary sum for each image of a set. For example, the n^{th} image being the n^{th} bit of the bit string, it is assigned a value of 2ⁿ⁻¹ for all pixels above the threshold of the binary filter for that image position. The resulting sum of images of the row set reveals the rows of display pixels found within the images of the camera for a specific channel. The same applies for the set of column images, where the columns of display pixels found within the images of the camera for a specific channel are now decoded.

The sum of all row encoding images multiplied by their bit encoding value is:

$${I}_{R - ch} = {\sum }_{n = 1}^{{n}_{R}} {I}_{{R}_{n - ch}} * {2}^{n - 1}$$

The sum of all column encoding images multiplied by their bit encoding value is:

$${I}_{C - ch} = {\sum }_{n = 1}^{{n}_{C}} {I}_{{C}_{n - ch}} * {2}^{n - 1}$$

### With:

n_{R}: being the number of row bits needed to encode the row pixel addresses;
n_{C}: being the number of column bits needed to encode the column pixel addresses;
I_{R}_{_{n-ch}}: being the row encoding image of specific row bit “n” of a channel “ch”; and
I_{C}_{_{n-ch}}: being the column encoding image of specific column bit “n” of a channel “ch”.

The resulting sum images, respectively for the row and column decoded positions within the images of the camera for a specific channel, allow to know exactly within the camera images, which and where the pixels of the display are located.

That is to say, the result of the decoding step allows the determining 1100 a mapping function that associates a plurality of image display pixels (k,l) of the image display device with a corresponding plurality of image capture pixels (i,j) of the image capture device of method 1000.

Back to method 1000, in some embodiments, determining 1200 an ideal image capture pixel (i′,j′) for one or more of the plurality of image display pixels (k,l) comprises: determining 1210 ideal image display space coordinates

$${[ x ; y ; z ]}_{k , l}^{d}$$

of the plurality of image display pixels (k,l); and determining 1220 ideal image capture space coordinates

$${[ x ; y ; z ]}_{i , j}^{c}$$

of the plurality of image capture pixels (i,j), wherein the ideal image display and image capture space coordinates indicate 3D positional information of the ideal image display and image capture pixels, respectively.

The computation of the initialized display pixel (k,l) positions

$${[ {x}_{0} ; {y}_{0} ; {z}_{0} ]}_{k , l}^{d}$$

is given by the following expressions and resulting positions:

$${[ \begin{matrix}{x}_{0} \\ {y}_{0} \\ {z}_{0}\end{matrix} ]}_{k , l}^{d} = [ \begin{matrix}{Δ}_{x - d} * ( l - {l}_{0} ) \\ {Δ}_{y - d} * ( k - {k}_{0} ) \\ 0\end{matrix} ] ;$$

with:
Δ_{x-d}: is display device pixel column width size;
Δ_{y-d}: is display device pixel row height size;
kₒ: is display device origin pixel row; and
lₒ: is display device origin pixel column.

After initialization, the image display space coordinates

$${[ x ; y ; z ]}_{k , l}^{d}$$

of a display device pixel (k,l) can be found at the following coordinates once a transformation is applied

$${[ \begin{matrix}x \\ y \\ z\end{matrix} ]}_{k , l}^{d} = {R ( {γ}_{d} )}_{z} {R ( {β}_{d} )}_{y} {R ( {α}_{d} )}_{x} {[ \begin{matrix}{x}_{0} \\ {y}_{0} \\ {z}_{0}\end{matrix} ]}_{k , l}^{d} + {[ \begin{matrix}{T}_{x} \\ {T}_{y} \\ {T}_{z}\end{matrix} ]}^{d} = {R}_{d} ( {γ}_{d} , {β}_{d} , {α}_{d} ) {[ \begin{matrix}{x}_{0} \\ {y}_{0} \\ {z}_{0}\end{matrix} ]}_{k , l}^{d} + \vec{{T}_{d}}$$

where:
R(γ_{d})_{z}: is a rotation matrix of an angle γ_{d} around the z axis;
R(β_{d})_{y}: is a rotation matrix of an angle β_{d} around the y axis;
R(α_{d})ₓ: is a rotation matrix of an angle α_{d} around the x axis;
R_{d}(α_{d},β_{d},γ_{d}): is a rotation matrix equivalent to all rotation matrices;
\vec{T_{d}}: is the translation vector applied to the display pixel positions;

$${T}_{x}^{d} :$$

is the x axis component of the translation vector \vec{T_{d}};

$${T}_{y}^{d} :$$

is the y axis component of the translation vector \vec{T_{d}}; and

$${T}_{z}^{d} :$$

is the z axis component of the translation vector \vec{T_{d}}.

In some embodiments, the known camera model, is a pinhole, model. Similarly, as for displays, we define the initialized pixel spatial coordinate

$${[ {x}_{0} ; {y}_{0} ; {z}_{0} ]}_{i , j}^{c}$$

and parameters for the camera:

$${[ \begin{matrix}{x}_{0} \\ {y}_{0} \\ {z}_{0}\end{matrix} ]}_{i , j}^{c} = [ \begin{matrix}{Δ}_{x − c} ⋆ ( j − {j}_{o} ) \\ {Δ}_{y − c} ⋆ ( i − {i}_{o} ) \\ 0\end{matrix} ] ;$$

where:
Δ_{x-c}: is the camera pixel column width size;
Δ_{y-c}: is the camera pixel row height size;
jₒ: is the display device origin pixel column; and
iₒ: is the display device origin pixel row.

Similarly, after initialization, the image capture pixel space coordinates

$${[ x ; y ; z ]}_{i , j}^{c}$$

of a capture device pixel (i,j) can be found at the following coordinates once a transformation has been applied:

$${[ \begin{matrix}x \\ y \\ z\end{matrix} ]}_{i , j}^{c} = {R ( {γ}_{c} )}_{z} {R ( {β}_{c} )}_{y} {R ( {α}_{c} )}_{x} {[ \begin{matrix}{x}_{0} \\ {y}_{0} \\ {z}_{0}\end{matrix} ]}_{i , j}^{c} + {[ \begin{matrix}{T}_{x} \\ {T}_{y} \\ {T}_{z}\end{matrix} ]}^{c} ;$$

In some embodiments, the convention is to only transform display pixel positions and leave capture device pixels as fixed within the spatial world coordinate system. Such referential can be transformed depending on the application. The camera spatial coordinate positions therefor remain the as the initialized values:

$${[ \begin{matrix}x \\ y \\ z\end{matrix} ]}_{i , j}^{c} = {[ \begin{matrix}{x}_{0} \\ {y}_{0} \\ {z}_{0}\end{matrix} ]}_{i , j}^{c} = {P}_{i , j}^{c} ;$$

### Where

$${P}_{i , j}^{c}$$

is the spatial coordinate of camera pixels (i,j).

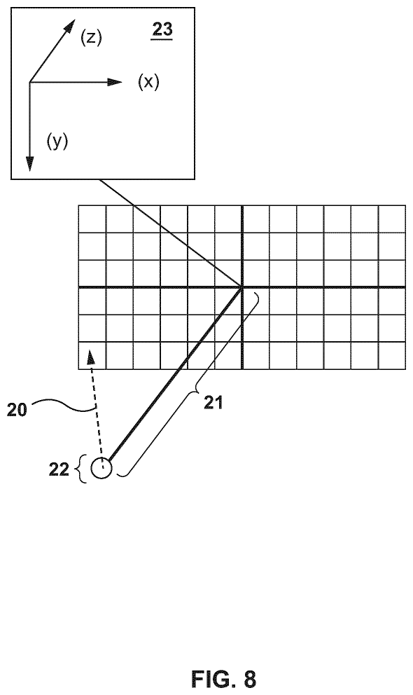

Back to method 1000, in some embodiments, the predetermined camera model is a pinhole model. FIG. 8 presents an ideal geometric representation of a fixed or focusable camera using a pin-hole model. The diagram illustrates the focal distance f denoted by (021), which signifies the distance between the focal point and the origin position of the sensor plane (i.e., the imaging plane). The focal point, point normal to the sensor plane at a distance f to the origin of the camera sensor.

The vector (020) represents the direction from the focal point to a specific pixel element located at row i and column j, denoted as \vec{vᵢⱼ}. Additionally, (023) indicates the camera referential system, where camera coordinates originate at the intersection of the origin column and origin row within the camera's frame.

In the embodiment where predetermined camera model is a pinhole model, determining 1200 an ideal image capture pixel (i′,j′) for one or more of the plurality of image display pixels (k,l) comprises: for each image display pixel (k,l), determining 1230 a line equation of a line that traverses a focal point of the image-forming optical system and the image display pixel (k,l); and determining 1240 an intersection between the line and an imaging plane of the image forming optical system, the intersection being the ideal image capture pixel (i′,j′).

That is to say, once the space coordinates are determined (1210 &1220), a line equation of a line that traverses a focal point of the image-forming optical system and the image display pixel (k,l) having space coordinates

$${[ x , ; y ; z ]}_{k , l}^{d}$$

is determined 1230. The line equation is given by:

$${L}_{k , l} ( {t}_{k , l} ) = ( {[ \begin{matrix}x \\ y \\ z\end{matrix} ]}_{k , l}^{d} − {[ \begin{matrix}0 \\ 0 \\ − f\end{matrix} ]}_{{i}_{o} , {j}_{o}}^{f} ) \cdot {t}_{k , l} + {[ \begin{matrix}0 \\ 0 \\ − f\end{matrix} ]}_{{i}_{o} , {j}_{o}}^{f}$$

The sensor plane of the camera can be arbitrarily set at the z=0 plane, therefore, the intersection with the sensor are determined by finding the value of t_{k,l} that makes the z component equal to 0 for the line equation

$$( i . e . , ( {[ z ]}_{k , l}^{d} - {[ - f ]}_{{i}_{o} , {j}_{o}}^{f} ) \cdot {t}_{k , l} + {[ - f ]}_{{i}_{o} , {j}_{o}}^{f} = 0 ) .$$

Therefore, t_{k,l} is given by:

$${t}_{k , l} = f / ( {[ z ]}_{k , l}^{D} + f )$$

The x and y components are found by putting the found t_{k,l} value back into the line equation. The intersection positions are given by:

$${Q}_{k , l} = ( {[ \begin{matrix}x \\ y \\ z\end{matrix} ]}_{k , l}^{Q} = {[ \begin{matrix}x \\ y \\ z\end{matrix} ]}_{k , l}^{d} − {[ \begin{matrix}0 \\ 0 \\ − f\end{matrix} ]}_{{i}_{o} , {j}_{o}}^{f} ) \cdot f / ( {[ z ]}_{k , l}^{t} + f ) + {[ \begin{matrix}0 \\ 0 \\ − f\end{matrix} ]}_{{i}_{o} , {j}_{o}}^{f}$$

The ideal image capture pixels (i′,j′) at the intersections can be found by simply writing the intersection spatial coordinates Q_{k,l} as a function of the camera pixel spatial coordinates:

$${Q}_{k , l} = {[ \begin{matrix}x \\ y \\ z\end{matrix} ]}_{k , l}^{Q} = [ \begin{matrix}{Δ}_{x - c} \cdot ( {j}^{′} - {j}_{o} ) \\ {Δ}_{y - c} \cdot ( {i}^{′} - {i}_{o} ) \\ 0\end{matrix} ] = {[ \begin{matrix}x \\ y \\ z\end{matrix} ]}_{{i}^{′} , {j}^{′}}^{c} = {P}_{{i}^{′} , {j}^{′}}^{c}$$

To be clear, the ideal image capture pixels (i′,j′) are given by:

$${Δ}_{x - c} \cdot ( {j}^{′} - {j}_{o} ) = {[ x ]}_{k , l}^{Q} ;$$

$${Δ}_{y - c} ( {i}^{′} - {i}_{o} ) = {[ y ]}_{k , l}^{Q} ;$$

$${i}^{′} = \frac{{[ y ]}_{k , l}^{Q}}{{Δ}_{y - c}} + {i}_{o} ;$$

$${j}^{′} = \frac{{[ x ]}_{k , l}^{Q}}{{Δ}_{x - c}} + {j}_{o} ;$$

Back to determining 1300 a correction function by reducing an error measure between the ideal image capture pixel (i′,j′) and the corresponding image capture pixel (i,j), the person skilled in the art would understand that this step could be performed using the ideal image capture pixel (i′,j′) and the corresponding image capture pixel (i,j), or using their cartesian coordinates directly.

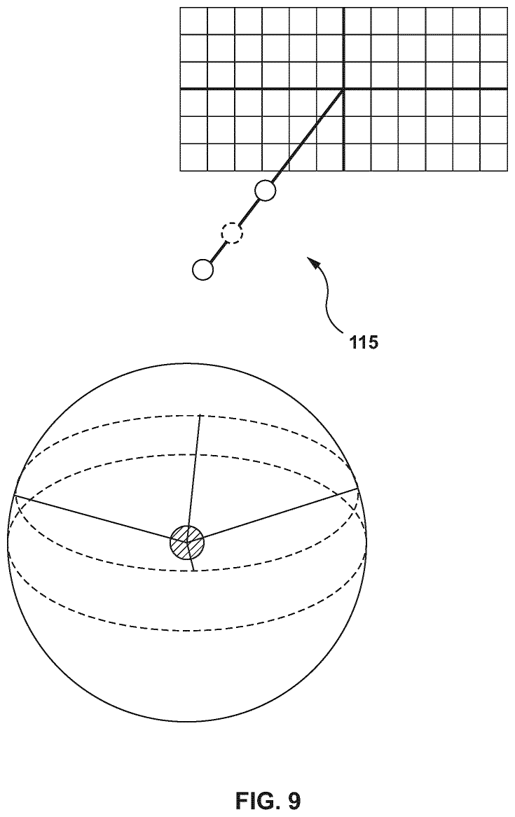

Back to method 1000, in some embodiments, the predetermined camera model is a fisheye model. FIG. 9 presents an ideal geometric representation of a fisheye camera-based model 115.

In the embodiment where predetermined camera model is a fisheye model, determining 1200 an ideal image capture pixel (i′,j′) for one or more of the plurality of image display pixels (k,l) comprises: for each image display pixel (k,l), determining 1250 a line equation of a line that traverses a focal point of the image-forming optical system and the image display pixel (k,l); and determining 1260 an intersection between the line and an imaging sphere, the intersection being the ideal image capture pixel (i′,j′).

In the case of a fisheye model, then the intersection equation changes to become the intersection with a sphere of radius f and arbitrarily centered at [0,0,0].

The sphere equation becomes:

$${f}^{2} = {x}^{2} + {y}^{2} + {z}^{2}$$

Since the focal point of the sphere is now at [0,0,0], the line equation from a display pixel becomes:

$${L}_{k , l} ( {t}_{k , l} ) = ( {[ x ; y ; z ]}_{k , l}^{D} - {[ 0 ; 0 ; 0 ]}_{{i}_{o} , {j}_{o}}^{f} ) \cdot {t}_{k , l} + {[ 0 ; 0 ; 0 ]}_{{i}_{o} , {j}_{o}}^{f}$$

The line equation is the set into the fisheye sensor equation:

$${f}^{2} = ( {( {[ x ]}_{k , l}^{D} )}^{2} + {( {[ y ]}_{k , l}^{D} )}^{2} + {( {[ z ]}_{k , l}^{D} )}^{2} ) \cdot {t}_{k , l}^{2} ⇔ {t}_{k , l}^{2} = \frac{{f}^{2}}{{( {[ x ]}_{k , l}^{D} )}^{2} + {( {[ y ]}_{k , l}^{D} )}^{2} + {( {[ z ]}_{k , l}^{D} )}^{2}}$$

Therefore, the intersections are given by:

$${t}_{k , l} = f / \sqrt{{( {[ x ]}_{k , l}^{D} )}^{2} + {( {[ y ]}_{k , l}^{D} )}^{2} + {( {[ z ]}_{k , l}^{D} )}^{2}}$$

The intersection points Q_{k,l} are

$${Q}_{k , l} = {[ \begin{matrix}x \\ y \\ z\end{matrix} ]}_{k , l}^{Q} = {[ \begin{matrix}x \\ y \\ z\end{matrix} ]}_{k , l}^{d} \cdot f / \sqrt{{( {[ x ]}_{k , l}^{d} )}^{2} + {( {[ y ]}_{k , l}^{d} )}^{2} + {( {[ z ]}_{k , l}^{d} )}^{2}}$$

The fisheye model pixel indices can be angular with elevation and azimuth arbitrarily set to the z axis as the 0 degree direction. The pixels can be instead defined with angular pitch angle. Each pixel with index (i,j) of the fisheye sensor can be found at the following coordinates on the sensor sphere using spherical coordinates with trigonometric functions:

$${[ \begin{matrix}{x}_{0} \\ {y}_{0} \\ {z}_{0}\end{matrix} ]}_{i , j}^{c} = f * [ \begin{matrix}sin ( {Δ}_{x - c} \cdot ( j - {j}_{o} ) ) \cdot cos ( {Δ}_{y - c} \cdot ( i - {i}_{o} ) ) \\ sin ( {Δ}_{x - c} \cdot ( j - {j}_{o} ) ) \cdot sin ( {Δ}_{y - c} \cdot ( i - {i}_{o} ) ) \\ cos ( {Δ}_{x - c} \cdot ( j - {j}_{o} ) )\end{matrix} ] = {P}_{i , j}^{c} ;$$

The sphere coordinates can be arbitrarily rotate to follow a specific camera convention. Using the z axis as the optical axis aligned with origin point of the sensor. It should be understood that any convention is included in the present description and that the spirit of the calculation encompasses any model or convention.

The pixel coordinates (i′,j′) can be found by isolating them in the above equation, by starting with the z component:

$${Q}_{k , l} = {[ \begin{matrix}x \\ y \\ z\end{matrix} ]}_{k , l}^{Q} = f * [ \begin{matrix}sin ( {Δ}_{x - c} \cdot ( {i}^{′} - {i}_{o} ) ) \cdot cos ( {Δ}_{y - c} \cdot ( {j}^{′} - {j}_{o} ) ) \\ sin ( {Δ}_{x - c} \cdot ( {i}^{′} - {i}_{o} ) ) \cdot sin ( {Δ}_{y - c} \cdot ( {j}^{′} - {j}_{o} ) ) \\ cos ( {Δ}_{x - c} \cdot ( j - {j}_{o} ) )\end{matrix} ] = {P}_{{i}^{′} , {j}^{′}}^{c} ;$$

$${j}^{′} = acos ( \frac{{[ z ]}_{k , l}^{Q}}{f} ) / {Δ}_{x - c} + {j}_{o}$$

$${i}^{′} = asin ( \frac{{[ y ]}_{k , l}^{Q}}{f * sin ( {Δ}_{y - c} \cdot ( {j}^{′} - {j}_{o} ) )} ) / {Δ}_{x - c} + {i}_{o}$$

As explained before, method 1000 comprises determining 1300 a correction function by reducing an error measure between the ideal image capture pixel (i′,j′) and the corresponding image capture pixel (i,j) of the one or more of the plurality of image display pixels (k,l), the correction function associating the one or more image capture pixels (i,j) with one or more corrected image capture pixels (i_{c},j_{c}).

In one embodiment, the ideal image capture pixel (i′,j′) is considered as the corrected image capture pixels (i_{c},j_{c}).

In some embodiments, the correction function is limited to rotations and/or translations of the image display pixels (k,l) and/or image capture pixels (i,j). In this case, the correction function to minimize can be written as:

$$F ( {α}_{d} , {β}_{d} , {γ}_{d} , \vec{{T}_{d}} , f ) = {Σ}_{i} {Σ}_{f} dist ( {P}_{{i}^{′} , {j}^{′}}^{c} - {P}_{i , j}^{c} ) :$$

being the function to minimize;
with:

$${P}_{{i}^{′} , {j}^{′}}^{c} :$$

being the computed intersection spatial coordinate of camera pixel (i,j);

$${P}_{i j}^{c} :$$

being the spatial coordinate of camera pixels (i,j);
dist( ): being a function measuring the Euclidian distance between 2 vectors;
\vec{T_{d}}: being a translation vector applied to the initialized display pixel coordinates; and
f: being the focal point distance of the camera model.

It is to be noted that different minimization functions may be used without substantial difference and all relate to the distance between the intersections and pixel coordinates.

In the case where the correction function is limited to rotations and/or translations, reducing the error measure may be performed by varying angles of the rotations and/or distances of the translations.

In one case, only one translation is considered for the whole set of pixels.

In another embodiment, the angles of the rotations and/or distances of the translations are simply set without any optimization thereof.

In one embodiment, reducing the error measure between the ideal image capture pixel (i′,j′) and the corresponding image capture pixel (i,j), comprises performing a minimization algorithm.

In some examples, the positions, orientations and model parameters minimizing the correction function define the spatial coordinates of the corrected ideal image capture pixels and image display pixels.

In some examples, the positions, orientations and model parameters are limited and minimizing the error measure is performed by varying one of more of the plurality of inputs of the correction function.

The image calibration method 1000 may be used for calibrating one or more image capture device channels and/or image display channels by applying the steps of the method to the one or more color channels.

In other embodiments, to enable the chromatic aberration correction, each channel of the camera is acquired in their respective display assignments.

We define:
G_{g-m}(i,j)ₘ=(i′,j′)ₘ: function mapping main channel camera pixels to main channel camera corrected pixels;
B_{g-m}(k,l)ₘ=(k′,l′)ₘ: function mapping main channel display pixels to main channel display corrected pixels;
G_{ch-m}(i,j)ₘ=(k,l)ₘ: function mapping main channel camera pixels to main channel display pixels;
G_{c-sc}(i,j)_{sc}=(k,l)_{sc}: function mapping subsequent channel camera pixels to same subsequent channel display pixels;
B_{ch-m}(k,l)ₘ=(i,j)ₘ: function mapping main channel display pixels to main channel camera pixels;
B_{ch-sc}(k,l)_{sc}=(i,j)_{sc}: function mapping subsequent channel display pixels to same subsequent channel camera pixels;
W_{sc}(k,l)ₘ=(i′,j′)_{sc}: function mapping main channel display pixels to subsequent channel camera pixels in the subsequent channel;
H_{sc}(l,j)ₘ=(k′,l′)_{sc}: function mapping main channel camera pixels to subsequent channel display pixels in the subsequent channel;

$${D}_{R - s c 2 m}^{c} :$$

as the row displacement matrix secondary channel sc to main channel m of camera;

$${D}_{C - s c 2 m}^{c} :$$

Column displacement matrix secondary channel sc to main channel m of camera;

$${D}_{R - m 2 r}^{c} :$$

Row displacement matrix main channel m to reference r of camera;

$${D}_{C - m 2 r}^{c} :$$

Column displacement matrix main channel m to reference r of camera;

$${D}_{R - sc 2 r}^{c} :$$

Row displacement matrix secondary channel sc to reference r of camera;

$${D}_{C - sc 2 r}^{c} :$$

Column displacement matrix secondary channel sc to reference r of camera;

$${D}_{R - sc 2 m}^{d} :$$

as the row displacement matrix secondary channel sc to main channel m of display;

$${D}_{C - sc 2 m}^{d} :$$

Column displacement matrix secondary channel sc to main channel m of display;

$${D}_{R - m 2 r}^{d} :$$

Row displacement matrix main channel m to reference r of display;

$${D}_{C - m 2 r}^{d} :$$

Column displacement matrix main channel m to reference r of display;

$${D}_{R - sc 2 r}^{a} :$$

Row displacement matrix secondary channel sc to reference r of display;

$${D}_{C - sc 2 r}^{d} :$$

Column displacement matrix secondary channel sc to reference r of display;
I_{d-o}: Raw image with M_{d} rows, N_{d} columns of pixels and C_{d} channels of display; (M_{d}*N_{d}*C_{d} matrix);
I_{d-r}: Corrected image with M_{d} rows, N_{d} columns of pixels and C_{d} channels of display;
I_{c-o}: Raw image with M_{c} rows, N_{c} columns of pixels and C_{c} channels of camera; (M_{c}*N_{c}*C_{c} matrix); and
I_{c-r}: Corrected image with M_{c} rows, N_{c} columns of pixels and C_{c} channels of camera.

In their own reference coordinate system, reference positions of displays, projectors or camera pixels are given by assigning a gridded matrix of positions to each pixel, so that the size of the position matrix for a dimension is the same as a channel of the image of the target device. The Cartesian coordinates may also be offset by subtracting the origin pixel position to the position matrices.

In general, the displacement matrices to bring an image from raw to reference state is given by a sum of displacement matrices, that are commutative, associative and distributive as such that any combination or reordering of the matrix operation would not change the resulting matrix but may yield greater computational efficiency.

The reference displacement matrices for a main channel of a camera are given by:

$$[ {E}_{R - c - 0} + {D}_{R - m 2 r}^{c} , {E}_{C - c - 0} + {D}_{C - m 2 r}^{c} ] = {G}_{g - r} ( {E}_{R - c - 0} , {E}_{C - c - 0} ) ;$$

$${{G}_{g - r} ( i , j )}_{m} \to {( {i}^{′} , {j}^{′} )}_{m} ;$$

The reference displacement matrices for a main channel of a display are given by:

$$[ {E}_{R - d - 0} + {D}_{R - m 2 r}^{d} , {E}_{C - d - 0} + {D}_{C - m 2 r}^{d} ] = {B}_{g - r} ( {E}_{R - d - 0} , {E}_{C - d - 0} ) ;$$

$${{B}_{g - r} ( k , l )}_{m} \to {( {k}^{′} , {l}^{′} )}_{m} ;$$

The displacement matrices for a secondary channel of a display d or camera c are given by:

$${D}_{R - s c 2 r}^{d} = {D}_{R - s c 2 m}^{d} + {D}_{R - m 2 r}^{d}$$

$${D}_{C - sc 2 r}^{d} = {D}_{C - sc 2 m}^{d} + {D}_{C - m 2 r}^{d}$$

$${D}_{R - sc 2 r}^{c} = {D}_{R - sc 2 m}^{c} + {D}_{R - m 2 r}^{c}$$

$${D}_{C - sc 2 r}^{c} = {D}_{C - sc 2 m}^{c} + {D}_{C - m 2 r}^{c}$$

where the secondary to primary channel displacement matrices for a display are given by:

$$[ {E}_{R - d - 0} + {D}_{R - sc 2 m}^{d} , {E}_{C - d - 0} + {D}_{C - sc 2 m}^{d} ] = {{H}_{sc} ( {E}_{R - d - 0} , {E}_{C - d - 0} )}_{m} ;$$

$${{H}_{sc} ( i , j )}_{m} \to {( {k}^{′} , {l}^{′} )}_{sc} ; and$$

where the secondary to primary channel displacement matrices for a display are given by:

$$[ {E}_{R - c - 0} + {D}_{R - sc 2 m}^{c} , {E}_{C - c - 0} + {D}_{C - sc 2 m}^{c} ] = {{W}_{sc} ( {E}_{R - c - 0} , {E}_{C - c - 0} )}_{m} ;$$

$${{W}_{sc} ( k , l )}_{m} \to {( {i}^{′} , {j}^{′} )}_{sc} ;$$

For a main channel, the final row and column remapping for a display d or camera c are given by:

$${E}_{R - c - r} = {E}_{R - c - 0} + {D}_{R - m 2 r}^{c} :$$

Corrected row positions of a camera main channel;

$${E}_{C - c - r} = {E}_{C - c - 0} + {D}_{C - m 2 r}^{c} :$$

Corrected column positions of a camera main channel;

$${E}_{R - d - r} = {E}_{R - d - 0} + {D}_{R - m 2 r}^{d} :$$

Corrected row positions of a display main channel;

$${E}_{C - d - r} = {E}_{C - d - 0} + {D}_{C - m 2 r}^{d} :$$

Corrected column positions of a display main channel;

For a secondary channel, the row and column remapping for a display d or camera c are given by:

$${E}_{R - d - r} = {E}_{R - d - 0} + {D}_{R - s 2 m}^{d} + {D}_{R - m 2 r}^{d} :$$

Corrected row positions of a display subsequent channel;

$${E}_{C - d - r} = {E}_{C - d - 0} + {D}_{C - s 2 m}^{d} + {D}_{C - m 2 r}^{d} :$$

Corrected column positions of a display subsequent channel;

$${E}_{R - c - r} = {E}_{R - c - 0} + {D}_{R - s 2 m}^{c} + {D}_{R - m 2 r}^{c} :$$

Corrected row positions of a camera subsequent channel;

$${E}_{C - c - r} = {E}_{C - c - 0} + {D}_{C - s 2 m}^{c} + {D}_{C - m 2 r}^{c} :$$

Corrected column positions of a camera subsequent channel.

It is to be noted that the final row and column remapping is considered the calibration matrix for geometric, chromatic, decentering corrections.

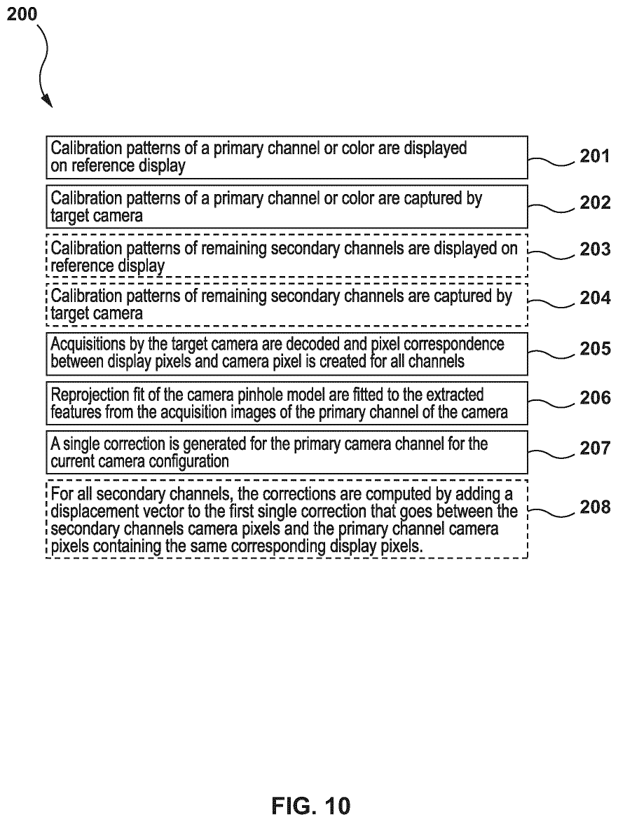

FIG. 10 shows flow chart diagram of a method 200 for calibrating a single configuration camera using a reference display. That is to say, method 200 allows calibrating one or more image capture device channels.

In accordance with FIG. 10, method 200 starts by displaying 201 calibration patterns of a primary channel or color on a reference display device. The calibration patterns of the primary channel or color are captured 202 by target camera (capture device).

In the case where the method 200 is applied to calibrate a plurality of image capture device channels, method 200 also comprises: displaying 203 calibration patterns of remaining secondary channels on reference display and capturing 204 calibration patterns of remaining secondary channels by target camera.

In both cases, acquisitions by the target camera are decoded 205 and pixel correspondence between display pixels and camera pixel is created for all channels. Then, reprojection fit of the camera pinhole model are fitted 206 to the extracted features from the acquisition images of the primary channel of the camera. Thereafter, a single correction is generated 207 for the primary camera channel for the current camera configuration.

In the case where the method 200 is applied to calibrate a plurality of image capture device channels, for all subsequent channels, the corrections are computed 208 by adding a displacement vector to the first single correction that goes between the subsequent channels camera pixels (i,j)_{sc} and the primary channel camera pixels (i,j)ₘ containing the same corresponding display pixels (k,l).

In essence, method 200 is used concurrently with method 1000 in such a way that, once the method 1000 is applied to a first channel, method 200 goes on to, for each subsequent channel of the one or more channels: determine a subsequent channel mapping function that associates a plurality of image display pixels (k,l)_{sc} of the subsequent channel with a corresponding plurality of image capture pixels (i,j)_{sc} of the subsequent channel, so that each image display pixel (k,l) is associated with a first image capture pixel (i,j)ₘ from the first channel and a second image capture pixel (i,j)_{sc} from the subsequent channel. A subsequent channel correction function is determined. The subsequent channel correction function is the sum between the correction function determined for the first channel and a displacement vector with the displacement vector being a vector that extends from the subsequent image capture pixel (i,j)_{sc} to the first image capture pixel (i,j)ₘ.

In some embodiments, the image calibration method 200 further comprises applying the correction function to one or more image capture pixels (i,j)ₘ of the first channel to obtain corrected image capture pixels (i_{c},j_{c})ₘ for the first channel; and/or applying the subsequent channel correction function to one or more image capture pixels (i,j)_{sc} of the second channel to obtain corrected image capture pixels (i_{c},j_{c})_{sc} for the second channel.

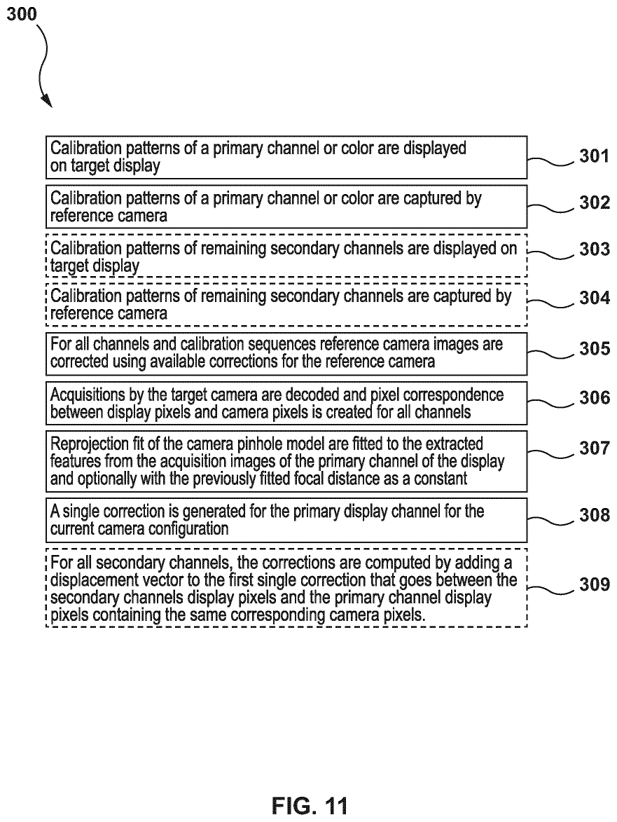

FIG. 11 shows flow chart diagram of a method 200 for calibrating a fixed display and projector using a reference camera. That is to say, method 200 allows calibrating one or more image display device channels.

In accordance with FIG. 11, method 300 starts by displaying 301 calibration patterns of a primary channel or color on a target display device. The calibration patterns of the primary channel or color are captured 302 by a reference camera (capture device).

In the case where the method 300 is applied to calibrate a plurality of image display device channels, method 300 also comprises: displaying 303 calibration patterns of remaining secondary channels on target display and capturing 304 calibration patterns of remaining secondary channels by the reference camera.

Then, in both cases, for all channels and calibration sequences, reference camera images are corrected 305 using available corrections for the reference camera.

Acquisitions by the target camera are decoded 306 and pixel correspondence between display pixels (k,l) and camera pixels (i,j) is created for all channels. Then, the minimization of an error function positioning the camera pinhole model completed 307 to the extracted features from the acquisition images of the primary channel of the display. Optionally, the reprojection fit is applied with the previously fitted focal distance as a constant. Thereafter, a single correction is generated 308 for the primary display channel for the current camera configuration.

In the case where the method 300 is applied to calibrate a plurality of image display device channels, for all secondary channels, the corrections are computed 309 by adding a displacement vector to the first single correction that goes between the secondary channels display pixels (k,l)_{sc} and the primary channel display pixels (k,l)ₘ containing the same corresponding camera pixels (i,j).

In essence, method 300 is used concurrently with method 1000 in such a way that, once the method 1000 is applied to a first channel, method 300 goes on to, for each subsequent channel of the one or more channels: determine a subsequent channel mapping function that associates a plurality of image display pixels (i,j)_{sc} of the subsequent channel with a corresponding plurality of image capture pixels (k,l)_{sc} of the subsequent channel, so that each image capture pixel (i,j) is associated with a first image display pixel (k,l)ₘ from the first channel and a second image display pixel (k,l)_{sc} from the subsequent channel. A subsequent channel correction function is determined. The subsequent channel correction function is the sum between the correction function determined for the first channel and a displacement vector with the displacement vector being a vector that extends from the second image display pixel to the first image display pixel.

In some embodiments, the image calibration method 300 further comprises applying the correction function to one or more image display pixels (k,l)ₘ of the first channel to obtain corrected image display pixels (k′,l′)ₘ for the first channel; and/or applying the subsequent channel correction function to one or more image display pixels (k,l)_{sc} of the second channel to obtain corrected image display pixels (k′,l′)_{sc} for the second channel.

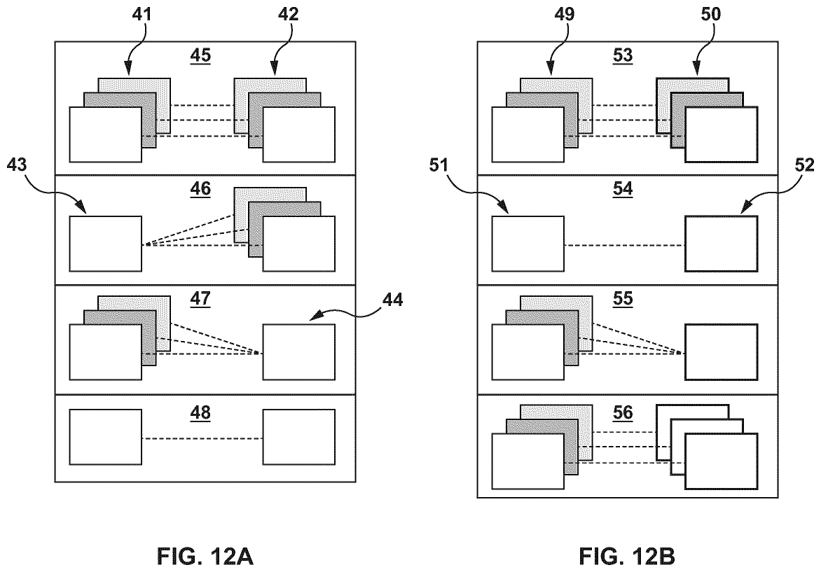

FIG. 12A shows a representation of chromatic and non-chromatic calibration using channel matching of a camera and display pair. (041) shows a first example where the camera is a multi-channel camera that has three image channels. In this first example, the display is a multi-channel display and has three image channels (042). (045) shows permissible channel configuration for chromatic correction of either camera or display for the first example.

(043) shows a second example where the camera is a mono-channel camera (i.e., the camera has one image channel). In this second example, the display is a multi-channel display and has three image channels. (046) shows permissible channel configuration for chromatic correction of display or non-chromatic correction of a camera for the second example. Please note, that in this configuration, only 1 channel is selected at a time.

(044) shows a third example where the display is a mono-channel display (i.e., the display has one image channel). In this third example, the camera is a multi-channel camera and has three image channels. (047) shows permissible channel configuration for non-chromatic correction of a camera or display.

Please note, that in this configuration, only 1 channel is selected at a time. That is to say, to correct a camera, the only display channel available is used for all camera channels. On the other hand, to correct a display, a channel of the camera is selected to assess the positions of the display. It could be a sum or average of all camera channels.

In a fourth example where the display and camera are mono-channel display and camera, (048) shows permissible channel configuration for non-chromatic correction of either the camera or display.

FIG. 12B shows a representation of chromatic and non-chromatic calibration using channel matching of a camera and a correction matrix. (049) shows a first example where the camera is a multi-channel camera that has three image channels. In this first example, the correction matrix is a multi-channel correction matrix (or vector) and comprises corrections for three image channels (050). (053) shows permissible channel configuration for chromatic correction of an imaging device image for the first example.

(051) shows a second example where the imaging device is a mono-channel imaging device (i.e., the imaging device has one image channel). In this second example, (051) represents an image channel of a mono channel correction matrix or vector. (054) shows permissible channel configuration for non-chromatic correction of an imaging device image.

(055) shows permissible channel configuration for non-chromatic correction of a mono channel imaging device image.

(056) shows permissible channel configuration for non-chromatic correction of a multi channel imaging device image using the same correction for all channels.

With respect to correcting varifocal systems, the method for correcting varifocal systems comprises selecting a first focal position f, as the reference. The first position is corrected according to the general method described in the document.

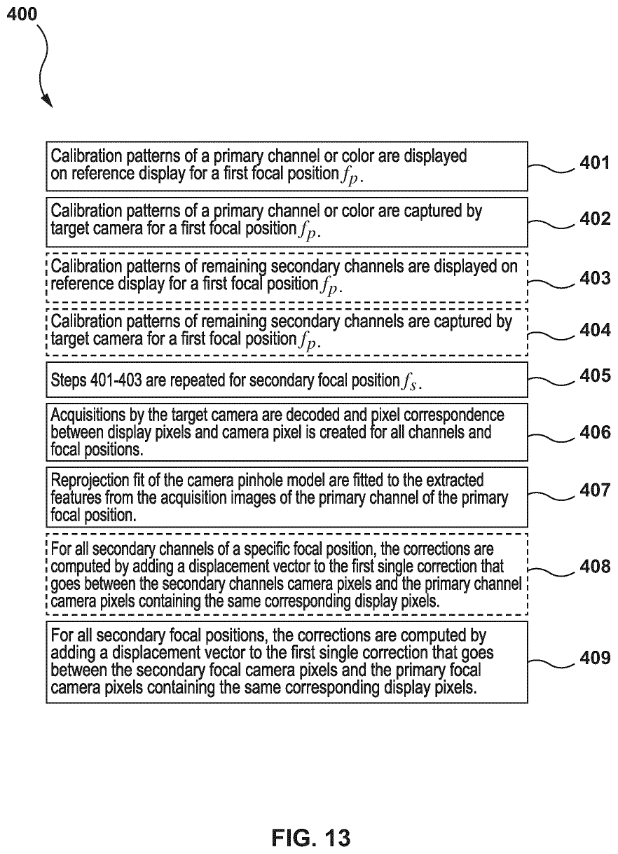

FIG. 13 shows flow chart diagram of a method 400 for calibrating a focusing camera using a reference display. That is to say, method 400 allows calibrating one or more image capture device channels of a focusing image capture device (also referred to as camera).

In accordance with FIG. 13, method 400 starts by displaying 401 calibration patterns of a primary channel or color on a reference display device for a first focal position fₚ. The calibration patterns of the primary channel or color are captured 402 by target camera (capture device) for the first focal position fₚ.

In the case where the method 400 is applied to calibrate a plurality of image capture device channels, method 400 also comprises: displaying 403 calibration patterns of remaining secondary channels on reference display the first focal position f, and capturing 404 calibration patterns of remaining secondary channels by target camera the first focal position fₚ.

Steps 401-404 are repeated 405 for each secondary focal position fₛ.

In both cases, acquisitions by the target camera are decoded 406 and pixel correspondence between display pixels and camera pixel is created for all channels and all focal positions. Then, reprojection fit of the camera pinhole model are fitted 407 to the extracted features from the acquisition images of the primary channel of the first focal position fₚ. Thereafter, a single correction is generated for the primary camera channel for the first focal position fₚ (not shown).

In the case where the method 400 is applied to calibrate a plurality of image capture device channels, for all secondary channels of a specific focal position, the corrections are computed 408 by adding a displacement vector to the first single correction that goes between the secondary channels camera pixels (i,j)_{sc} and the primary channel camera pixels (i,j)ₘ containing the same corresponding display pixels (k,l).

For all secondary focal positions fₛ, the corrections are computed 409 by adding a displacement vector to the first single correction that goes between the secondary focal fₛ camera pixels (i,j)ₛ and the primary focal fₚ camera pixels (i,j)ₚ containing the same corresponding display pixels.

In essence, method 400 is used concurrently with method 1000 in such a way that, once the method 1000 is applied to a first focal position f, of the focusing image capture device, method 400 goes on to, for each subsequent focal position: determine a subsequent mapping function that associates a plurality of image display pixels (k,l)ₛ of the subsequent focal position fₛ with a corresponding plurality of image capture pixels (i,j)ₛ of the subsequent focal position, so that each image display pixel (k,l) is associated with a first image capture pixel (i,j)ₚ from the first focal position and a second image capture pixel (i,j)ₛ from the subsequent focal position; and determine a subsequent correction function that is the sum between the correction function determined for the first focal position and a displacement vector, the displacement vector being a vector that extends from the subsequent image capture pixel (i,j)ₛ to the first image capture pixel (i,j).

Once the correction for each first channel of each focal position is determined, for each subsequent channel of each focal position, method 400 goes to: determining a subsequent channel mapping function that associates a plurality of image display pixels (k,l)_{sc} of the subsequent channel with a corresponding plurality of image capture pixels (i,j)_{sc} of the subsequent channel, so that each image display pixel (k,l) is associated with a first image capture pixel (i,j)ₘ from the first channel and a second image capture pixel (i,j)_{sc} from the subsequent channel, and determining a subsequent channel correction function that is the sum between the subsequent channel correction function determined for the first channel and a displacement vector, the displacement vector being a vector that extends from the subsequent image capture pixel (i,j)_{sc} to the first image capture pixel (i,j)ₘ.

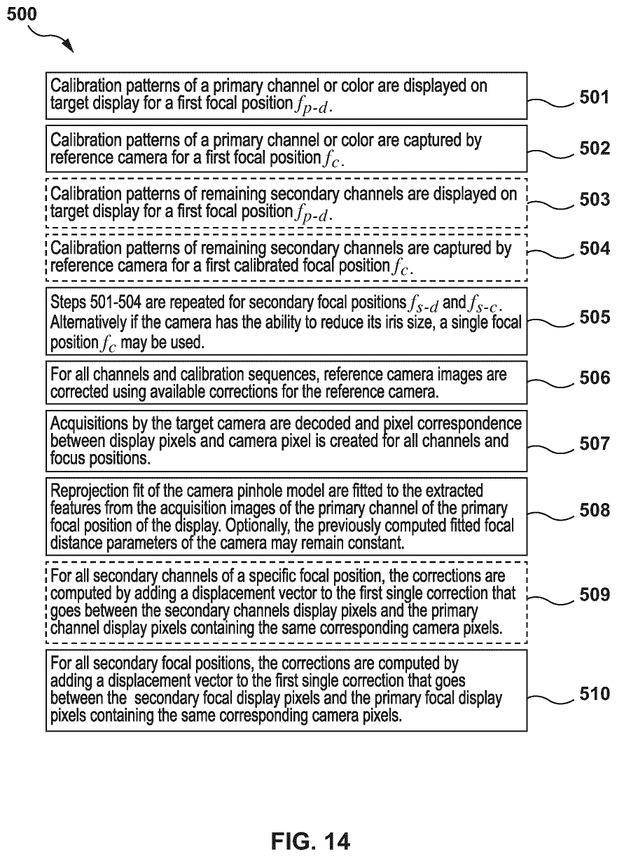

FIG. 14 shows flow chart diagram of a method 500 for calibrating a focusing display and projector using a reference camera. That is to say, method 500 allows calibrating one or more image display device channels of a focusing image display device (also referred to as display and projector).

In accordance with FIG. 14, method 500 starts by displaying 501 calibration patterns of a primary channel or color on a target display device for a first display device focal position f_{p-d}. The calibration patterns of the primary channel or color are captured 502 by the reference camera (capture device) for the first focal position f_{p-d}. The camera itself has a focal position f_{c} that can see the display patterns clearly.

In the case where the method 500 is applied to calibrate a plurality of image display device channels, method 500 also comprises: displaying 503 calibration patterns of remaining secondary channels on target display for the first display device focal position f_{p-d} and capturing 504 calibration patterns of remaining secondary channels by reference camera for the first focal position f_{p-d}.

In one embodiment, steps 501-504 are repeated 505 for each secondary focal of the display at position f_{s-d}.

Then, for all channels and calibration sequences, reference camera images are corrected 506 using available corrections for the reference camera.

Thereafter, acquisitions by the target camera are decoded 507 and pixel correspondence between display pixels (k,l) and camera pixels (i,j) is created for all channels and all display focal positions. Then, the fit of camera and display pair are fitted 508 to the extracted features from the acquisition images of the primary channel of the first focal position f_{p-d}. In some embodiments, the previously computed fitted focal distance parameter of the camera may remain constant and parameters of the primary fit may be reused for all subsequent focal position f_{s-d}.

Thereafter, a single correction is generated for the primary camera channel for the first focal position f_{p-d} (not shown).

In the case where the method 500 is applied to calibrate a plurality of image display device channels, for all secondary channels of a specific focal position, the corrections are computed 509 by adding a displacement vector to the first single correction that goes between the secondary channels display pixels and the primary channel display pixels containing the same corresponding camera pixels.

For all secondary display focal positions f_{s-d}, the corrections are computed 510 by adding a displacement vector to the first single correction that goes between the secondary focal f_{s-d} display pixels and the primary focal f_{p-d} display pixels containing the same corresponding camera pixels.

In essence, method 500 is used concurrently with method 1000 in such a way that, once the method 1000 is applied to a first focal position f_{p-d} of the focusing image display device, method 500 goes on to, for each subsequent display focal position f_{s-d}: determine a subsequent mapping function that associates a plurality of image display pixels (k,l)ₛ of the subsequent focal position with a corresponding plurality of image capture pixels (i,j)ₛ of the subsequent focal position, so that each image capture pixel (i,j) is associated with a first image display pixel (k,l)ₚ from the first focal position f_{p-d} and a second image display pixel (k,l)ₛ from the subsequent focal position f_{s-d}; and determine a subsequent correction function that is the sum between the correction function determined for the first focal position and a displacement vector, the displacement vector being a vector that extends from the subsequent image display pixel to the first image display pixel.

Once the correction for each first channel of each focal position is determined, for each subsequent channel of each focal position, method 500 goes to: determine a subsequent channel mapping function that associates a plurality of image display pixels (k,l)_{sc} of the subsequent channel with a corresponding plurality of image capture pixels (i,j)_{sc} of the subsequent channel, so that each image capture pixel (i,j) is associated with a first image display pixel (k,l)ₘ from the first channel and a second image display pixel (k,l)_{sc} from the subsequent channel, and determine a subsequent channel correction function that is the sum between the subsequent channel correction function determined for the first channel and a displacement vector, the displacement vector being a vector that extends from the subsequent image display pixel to the first image display pixel.

With respect to correcting zoom systems, the method for correcting zoom systems where the field-of-view varies comprises selecting a first zoom position zₚ as the reference. Typically, the lowest zoom magnification would be selected as the reference. The first position is corrected according to the general method described in the document. The parameters including the position, orientation and central pixels are kept constants for all other subsequent zoom positions zₛ. In a second time, another zoom position is selected zₛ. This time, the focal distance, of the camera sensor is fitted, while keeping the position and orientation constant. The reprojection is then done for the given fitted and constant parameters. The correction displacement matrix is then given by the difference between the reprojected points and the fitted points. This correction allows a constant orientation, a constant position in a camera or display image regardless of current magnification of the system. Notable characteristic of this correction is the constant position of the center of the image, which is highly useful for zoom implementations used by targeting systems.

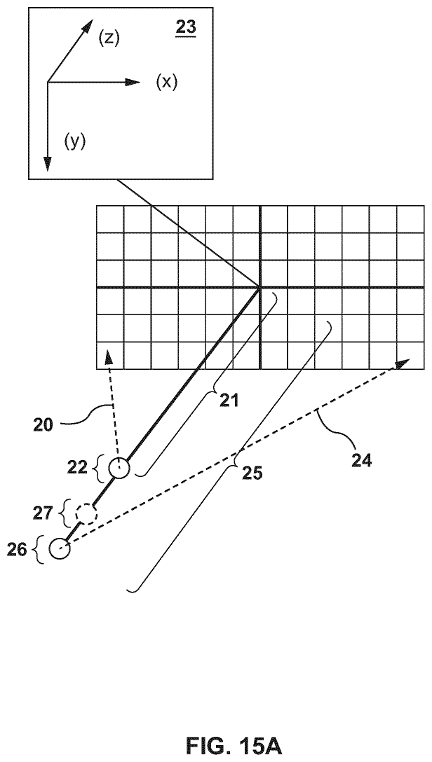

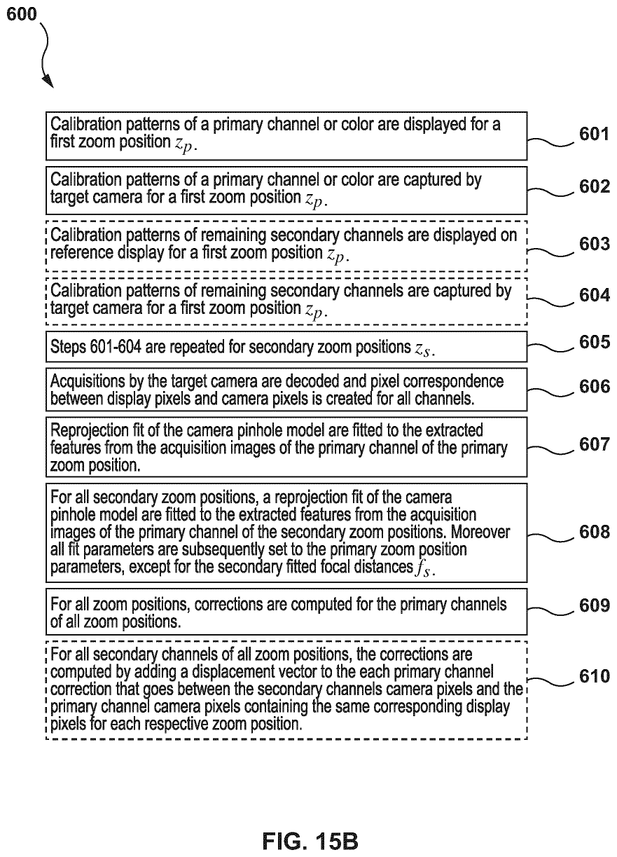

FIG. 15A shows an ideal geometric representation of a zooming camera pin-hole model. (023) represents camera coordinates originating at the origin column and origin row intersection for the camera referential. (022) shows a focal point where all vectors of pixel elements start from at a z distance f from the sensor plane (imaging plane). (021) represents the focal distance f between the focal point and the sensor plane origin position. (020) shows a focal point to pixel element vector representing the direction of a pixel of row i and column j as i_{J}.

(026) depicts a secondary focal point. (025) is the focal distance between the secondary focal point and the sensor plane (imaging plane) origin position. (024) shows a secondary focal point to pixel element vector representing the direction of a pixel located at row i and column j.

(027) is an interpolated focal point with interpolatable parameters.

FIG. 15B shows flow chart diagram of a method 600 for calibrating zooming image capture device having one or more channels. That is to say, method 600 allows calibrating one or more image capture device channels of a zooming image capture device (also referred to as camera).

In accordance with FIG. 15B, method 600 starts by displaying 601 calibration patterns of a primary channel or color on a reference display device for a first zoom position zₚ. The calibration patterns of the primary channel or color are captured 602 by target camera (capture device) for the first zoom position zₚ.

In the case where the method 600 is applied to calibrate a plurality of image capture device channels, method 600 also comprises: displaying 603 calibration patterns of remaining secondary channels on reference display for the first zoom position zₚ and capturing 604 calibration patterns of remaining secondary channels by target camera for zoom position zₚ.

Steps 601-604 are repeated 605 for each secondary zoom position zₛ.

In both cases, acquisitions by the target camera are decoded 606 and pixel correspondence between display pixels and camera pixel is created for all channels and all zoom positions. Then, reprojection fit of the camera pinhole model are fitted 607 to the extracted features from the acquisition images of the primary channel for the first zoom position zₚ.

For all secondary zoom positions zₛ, a reprojection fit of the camera pinhole model is fitted 608 to the extracted features from the acquisition images of the primary channel of the secondary zoom positions. In this case, all fit parameters are subsequently set to the ones of the primary zoom position parameters, except for the secondary fitted focal distances.

Thereafter, corrections are generated 609 for the primary camera channel for each zoom position.

In the case where the method 600 is applied to calibrate a plurality of image capture device channels, for all secondary channels of a specific zoom position, the corrections are computed 610 by adding a displacement vector to each primary channel correction, the displacement vector goes between the secondary channel camera pixels (i,j)ₛ and the primary channel camera pixels (i,j)ₚ containing the same corresponding display pixels (k,l).

In essence, method 600 is used concurrently with method 1000 in such a way that, once the method 1000 is applied to each first channel of each zoom position of the zooming image capture device, for each subsequent channel of each focal position, method 600 goes to: determining a subsequent channel mapping function that associates a plurality of image display pixels (k,l)_{sc} of the subsequent channel with a corresponding plurality of image capture pixels (i,j)_{sc} of the subsequent channel, so that each image display pixel (k,l) is associated with a first image capture pixel (i,j)ₘ from the first channel and a second image capture pixel (i,j)_{sc} from the subsequent channel, and determining a subsequent channel correction function that is the sum between the subsequent channel correction function determined for the first channel and a displacement vector, the displacement vector being a vector that extends from the subsequent image capture channel pixel to the first image capture channel pixel.

In embodiments where the capture device is mono-channel, method 600 for calibrating a zooming image capture device comprises performing the method 1000 for each desired zoom position.

The corrections for an imaging system multiple configurations allow for interpolation between the calibration positions, including focal positions, polarization states, magnification positions or optical configuration. For example, 4 correction positions for 1×, 5×, 10×, 15 magnifications positions allow interpolation and extrapolation at any intermediate and continuous position, meaning that position 1.5× could be interpolated from available corrections. The interpolation method can be of any conventional 1D interpolation method, use 1, 2 or more of the corrections with weighted contributions. A polynomial of any ‘n’ degree may be computed from ‘n+1’ correction positions for each row and column matrix element. The interpolation happens on a per matrix element basis, namely the second dimension ‘y’, between each configuration, namely the first dimension ‘x’ in an interpolation formula.

As is apparent now, in some embodiments, method 1000 may further be used for calibrating a multi-parameter image capture device. Once the corrected pixels are determined for a plurality of camera multi-parameter configurations, for a multi-parameter configuration associated with a new image capture device configuration, method 1000 further comprises: interpolating the corrected pixels determined for the plurality of image capture device multi-parameter configurations to obtain corrected pixels associated with the new image capture device configuration.

In some embodiments, the image capture device multi-parameter configurations comprise one or more of: focal positions, magnification, polarization states, and device geometry.

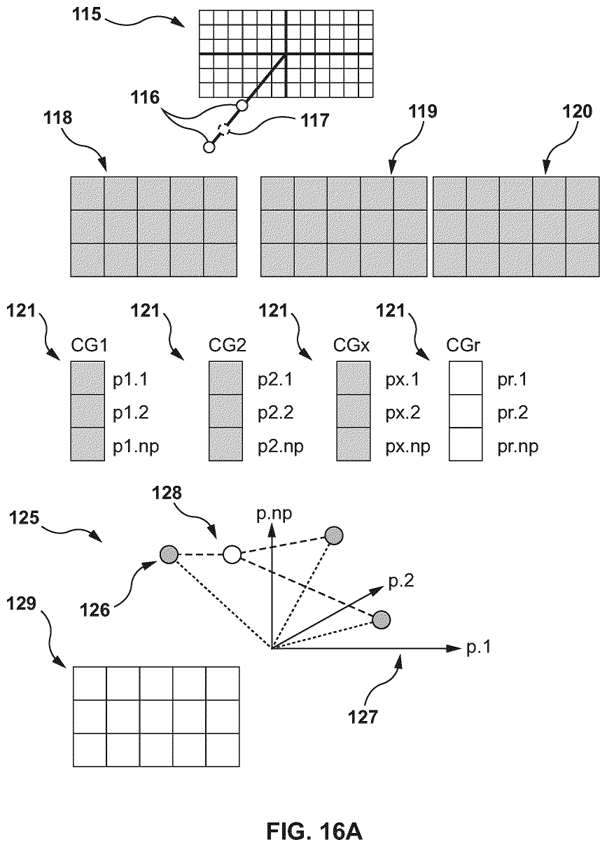

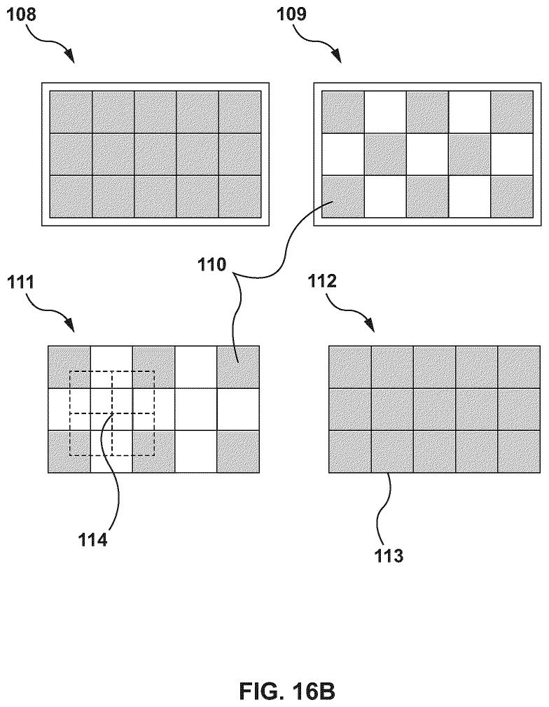

FIG. 16A shows a representation of correction interpolation between multi-parameter configurations in which (115) denotes configuration matrix of a camera with multiple magnification positions and multiple magnification position calibrations stored. (116) shows positions where the zoom and/or focal positions are calibrated and (117) shows a requested position of calibration.

Each of (118), (119), and (120) shows a representation of a correction for an arbitrary imaging device configuration G₁, G₂, and Gₛ, respectively. Each configuration could be a combination of nₚ parameters such as: focal position, magnification, polarization state, spectral band, device geometry, etc.

Each of (121), (122), and (123) shows a configuration vector C_{G1}, C_{G2}, and C_{Gs} respectively. Each configuration vector comprises nₚ parameters where a calibration has been done previously. In FIG. 16A, a parameter number is denoted p_{c.n}, where n is the index within the vector and c is the number of the calibration configuration.

(124) shows a requested ternary configuration vector C_{Gs} where no calibration has been done.

(125) is a representation of an nₚ dimensional multivariate interpolation scheme to recover the correction matrix for the specific configuration vector C_{Gs}. Note that any interpolation scheme may be used with any number of points available. (127) shows C_{G} base vector axes representation (i.e., the multidimensional base vectors).

(128) shows a requested correction vector position within the base and (126) shows the available corrections in vector space of nₚ dimensional coordinates.

(129) is simply a representation of an interpolated or extrapolated correction matrix of the requested configuration vector C_{Gs}.

It is now apparent that the teachings of the methods discussed herein may be applied to all pixels of an image capture device and/or image display device in one embodiment.

In another embodiment, the teachings of the methods discussed herein may be applied to a subset of pixels of an image capture device and/or image display device corrected pixels of remaining image pixels are obtained by interpolating adjacent corrected pixels or any available pixels.

FIG. 16B shows a representation of decimated or missing pixel correction values using 2D interpolation. (108) is a representation of a single channel of a display image with encoded addresses of the rows or columns with full density encoding. (109) shows an arbitrary decimation scheme aimed at reducing the resolution of a calibration to reduce complexity or time of calibration with reduced density encoding. This initially create sparse correction matrices, but the missing values can be interpolated using the teachings of the present disclosure.

(110) shows a populated pixel element meant to demonstrate the presence of encoding or correction information within the pixel. (111) depicts a representation of a single channel from a row or column correction matrix with missing or not available values. (112) shows a representation of a single channel from a row or column correction matrix with full density of values, with some elements being interpolated.

(113) shows an interpolated pixel element derived from the nearby pixel elements using interpolation or extrapolation techniques. (114) is a simple representation of the neighboring elements being used to compute a missing pixel element.

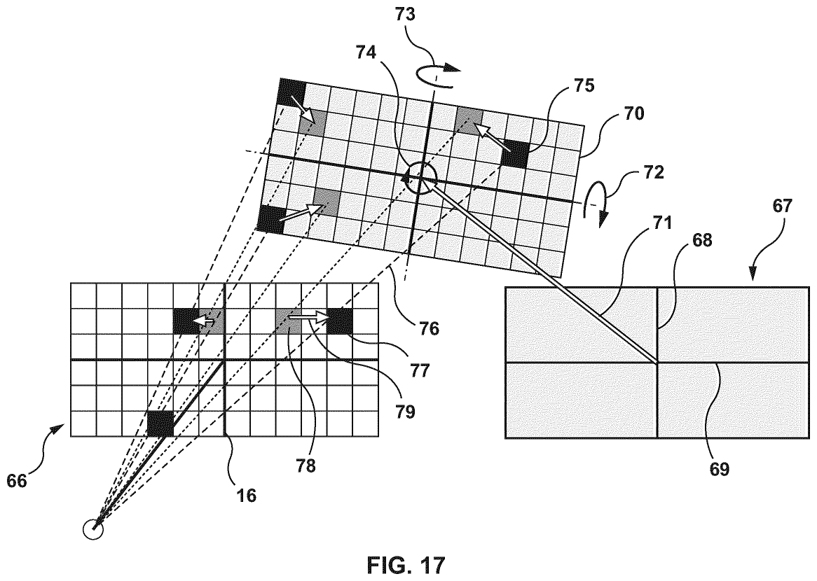

FIG. 17 shows a representation of reprojection fitting of a pinhole camera model and display pair fit in which element (066) represents an initialized ideal geometric pinhole camera. The position P_{c}(x_{c},y_{c},z_{c}) and orientation O_{c}(a,b,c) and focal distance f_{c} of the camera are either fitted to minimize reprojection error of all its pixels positions within a camera image or predefined depending on the nature of the calibration.

Element (067) represents an initialized ideal geometric display. The position P_{d}(x_{d},y_{d},z_{d}) and orientation O_{d}(α,β,γ) of the display are either fitted to minimize reprojection error of all its pixels positions within a camera image or predefined depending on the nature of the calibration. (068) is an arbitrarily selected origin column of the display as the β rotation axis and (069) is an arbitrarily selected origin row of the display as the α rotation axis.

Element (070) represents fitted ideal geometric position of the display position P_{d}(x_{d},y_{d},z_{d}) and orientation O_{d}(α,β,γ) that minimize reprojection error of all its pixels positions within a camera image. Element (071) shows a translation vector \vec{T_{d}} with x,y,z components to be optimized for the fitting step. The translation vector moves the display origin to a new fitted position. Element (072) shows a rotation angle about α axis of display x origin referential to be optimized for the fitting step. Element (073) shows a rotation angle about β axis of display y origin referential to be optimized for the fitting step. Element (074) shows a rotation angle about y axis of display z origin referential to be optimized for the fitting step. (075) shows a decoded display pixel with known display row and column (k,l). Element (076) shows a vector \vec{Vᵢⱼ}(k,l) from a decoded display pixel (k,l) to the focal point of the ideal pinhole camera model. (077) shows the position where ideal found camera pixel would be in a perfect system with known decoded display pixel row and column (k,l). (078) shows the position where the camera pixel (i,j) with known decoded display pixel row and column (k,l) is actually found.

(079) shows the displacement needed to move a camera pixel to the pixel location which would superpose it with the ideal found camera pixel. Doing so for all camera pixels and channels gives the camera correction matrix.

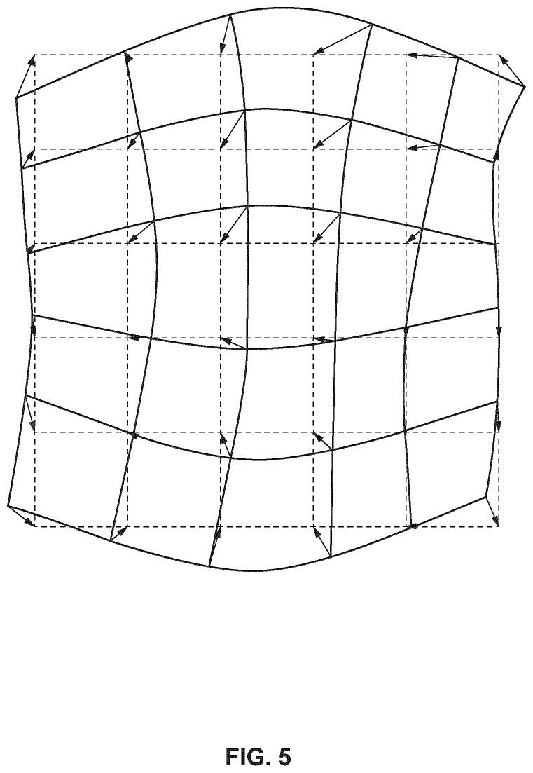

FIG. 5 shows an example distorted image and corrections computed using the teachings of the present disclosure to calibrate the camera and/or display from which the image is acquired. Once the corrections are computed, the camera and/or display can become reference camera and/or display.

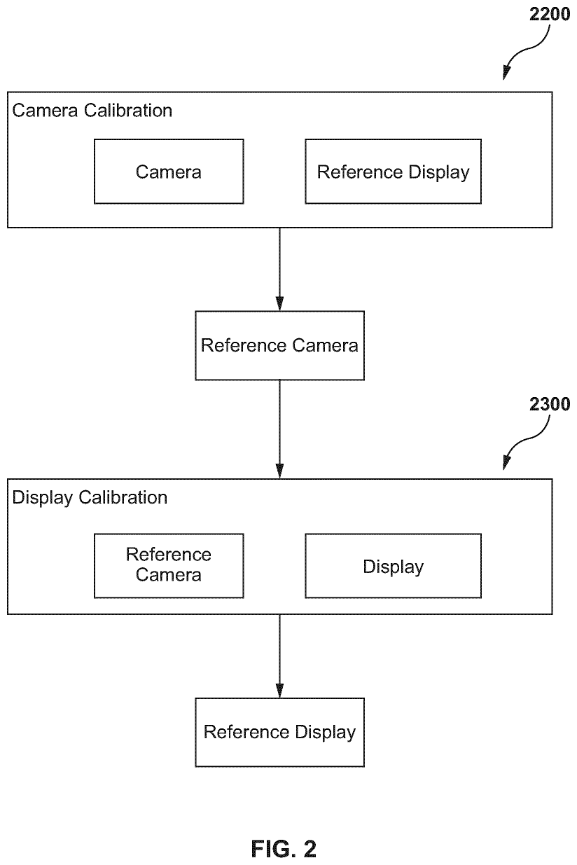

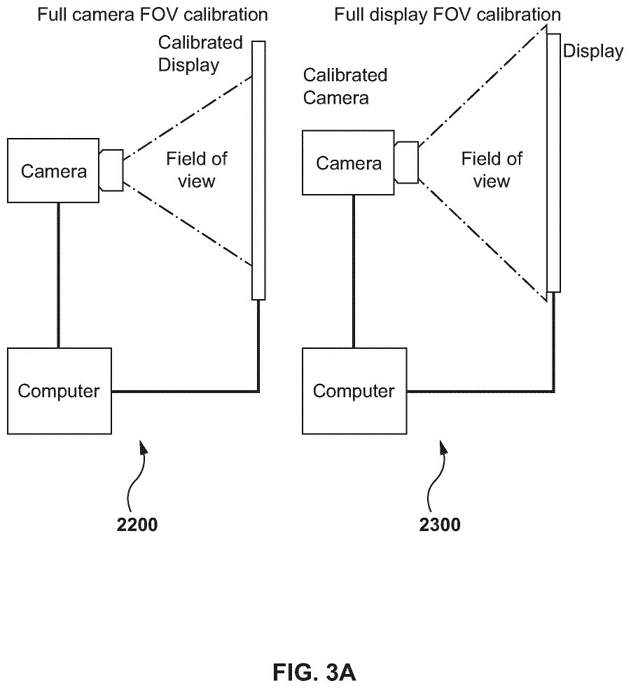

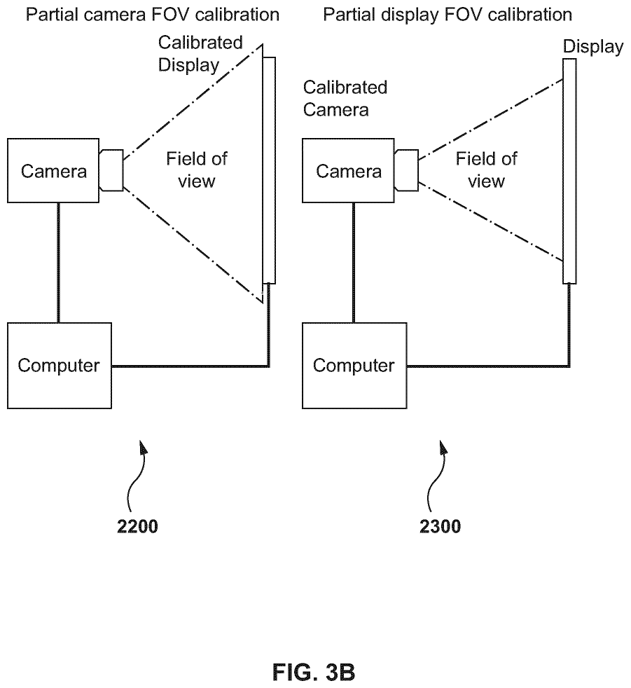

In some embodiments, and in accordance with FIGS. 2, 3A, and 3B, the method of the present disclosure may include a first camera calibration to create 2200 an ideal reference camera, which can be used to further calibrate other displays or projectors. This first calibration 200 may be done using a reference display. The size, colors, resolution or type of display or projector is chosen to suit the application of the cameras under calibration. The initial camera calibration may comprise any of the following corrections, in any order or combination to conduct and compute bright-dark field calibration, vignetting correction, image center decentering calibration, chromatic aberration removal, geometric distortion correction, field-of-view pixel orientation retrieval, ideal pinhole model camera transfer function, parse or complete image pixel remapping.

In accordance with FIGS. 2, 3A, and 3B, once a camera has been calibrated it is now referred to as a reference camera, transformed to a pinhole camera model. Further calibration 2300 of displays or projectors is possible by undergoing the same sequence of images as the previous embodiment but applying the transformation and calibration process to the display or projector images instead of the camera. The images of the camera may use previous calibration transformations to rectify the raw output images of the camera before the transformations for the displays or projectors are computed. The display or projector images are corrected to become rectilinear in the reference camera images and may comprise any of the following corrections, in any order or combination to conduct and compute bright-dark field calibration, vignetting correction, image center decentering calibration, chromatic aberration removal, geometric distortion correction, field-of-view pixel orientation retrieval.

In accordance with another embodiment, an apparatus for camera, display and projector is proposed. The apparatus may include a monitor, display, projector, or image displaying device of any kind, including time-space synchronized, rastering or scanning technologies. The apparatus may also include a camera or optical imaging device of any kind, resolution, number of channels, wavelength response with any kind of entrance optics. The apparatus may include a processor for computing the correction functions, storing images, and completing sequences of acquisition using the apparatus described in this embodiment. The minimum requirement is to have at least 1 camera and at least 1 display. The apparatus may use a single or multiple cameras and a single or multiple displays at the same time. The general strategy to correct displays and cameras alike is to first calibrate a camera using a reference display, e.g. a regular monitor, and then use this camera to further calibrate displays part of optical systems or calibrate the relative positions of displays and cameras.

With respect to FIG. 2, in the case of camera calibration, the first calibration to be done is the calibration of the camera using a reference display. Typically, a regular flat display of any size can be described to be of high enough quality and regularity to be considered as a reference display. As such, an appropriate reference display is chosen to occupy a fraction or all of the camera's imaging field-of-view. In order to fully calibrate images from a camera, a camera is pointed towards a reference display and both are connected to a computer that synchronizes the image sequence acquisition between the camera and display. The computer also serves the role of computing the correction that will be later applied to the output images of the camera being calibrated. The resulting images of the camera, once processed with the correction that was computed, will be considered to be corrected. A camera whose images are processed with the computed correction will be considered to be a reference camera. Once a camera becomes a reference camera, it is now used to correct displays. For example, and with respect to FIGS. 3A and 3B, the present method may correct the entire field-of-view of a camera by ensuring that the field-of-view of the camera is fully covered by the reference display area, which would provide a full field-of-view calibration, but it may also only include a display that partially covers the field-of-view of the camera. The regions covered by the display image region would still allow for accurate corrections within the covered region and the rest of the non-covered region correction can be computed by use of standard extrapolation methods. Similarly, the whole display may be fully corrected if its entire area is visible within the reference camera field-of-view. The display may also be partially visible in the reference camera's field-of-view, and the remaining non-visible region correction can be computed using standard extrapolation methods. With respect to FIG. 3A, there is illustrated a non-limiting schematic whereby the camera's full field-of-view calibration requires the patterns of the reference display or projector to fill the whole field of view of the camera. The display's or projector's full field-of-view calibration requires the patterns of the display or projector to be fully visible within the field-of-view of the camera.

With respect to FIG. 3B, the camera's partial field-of-view calibration requires a portion of the patterns of the reference display or projector to partially fill the whole field of view of the camera. The display's or projector's partial field-of-view calibration requires the patterns of the display or projector to be partially visible within the field-of-view of the camera. In the instance where the field-of-view is partially filled, the calibration would correct the region of camera images where the pattern is visible, and an extrapolation method could be used to complete the calibration of regions where no pattern is visible.

In some embodiments, the method of the present disclosure aims at correcting the images of camera and display systems. The corrections involve the correction of geometric and visual distortions in images taken by a camera, displayed to a user's eye or other camera system.

The geometric distortion is caused by the optics affecting the light path of wavefronts of optical light. The distortions are removed by deforming the images in a way that the output corrected images appear to be rendered in the perspective of a perfect pinhole model camera. This geometric distortion correction can be applied to displays and cameras alike, be applied to each channel of a device, either individually corrected or corrected with an encompassing calibration matrix to all channels at one time.

Depending on the use case, the correction can also be reprojected to a fish-eye lens model, or a spherical perspective to create composite images with accurate stitching between multi camera systems.

In some embodiments, the corrections can be inverted to transform a perfect pin-hole camera model into a camera with the same distortions found in the targeted camera, which can be useful, for example, in implementing distortions to virtual images to be fed to machine learning models.

The correction also involves the removal of chromatic separation of light within the rendered image, namely, chromatic aberrations. This correction applied to secondary channels allows to remap the secondary channels pixel position to a main channel. This reassignment of pixel positions allows for features that are supposed to be located at the same position within an image or object, to remain superposed in the perspective of an user in the case of displays, and to remain superposed in an image taken by a camera. Colors in images are often approximated using filters and the combination of the color ratios allow a user to visualize colors in a way that is equivalent to the original intended colors. This correction may be applied to all or some secondary channels to enable the superposition of features within different channels to a main channel.

Another correction is focus and zoom decentering correction. This correction allows to ensure that a camera or display image with optics at different zoom levels or focal positions, to maintain consistency in the perspective of a pinhole camera model. In the case of zoom correction, the constants are the origin of the image in pixels, the position of the camera, the orientation of the camera, number of camera pixel rows and columns, the size of the pixels and allows the variation of the distance of the pinhole to sensor center pixels, along the fixed normal of the optical axis. The variation of the distance of the pinhole to sensor center pixel is often described as the focal length of the pinhole model. This length, when changed, allows the magnification of the pinhole model to be changed while maintaining consistency in the expected perspective of the camera or user. As for the focus decentering correction, the constants are the center of the image in pixels, the position of the camera, the orientation of the camera, number of camera pixel rows and columns, the size of the pixels and the distance of the pinhole to sensor center pixels, along the fixed normal of the optical axis. This correction allows to maintain the position of objects in images of a camera or in the perspective of a user for a display. When the focal plane is changed, an ideal optical system should retain the same perspective between the positions of features within an image.

Another correction is the vignetting or intensity calibration of camera images or display images in the perspective of a user or other camera. The variation of the intensity of a display or camera image is due to the varying efficiency of optical elements in bringing light to a sensor, a user's eye or another camera. To correct the intensity non-uniformities, the correction assesses the intensity of uniform flat field of light within a camera image and applies a correction that scales the image pixel intensities to display a uniform image. By finding the pixel locations of a calibrated display in the images of cameras, the camera images can be scaled in intensity to provide an image where each point of the display appears to be of the same intensity. This is better done when the display is normal to the camera. Similarly, if one uses a calibrated camera, the camera may be used to correct the non-uniformities within a display image. The assessment of point spread function calibration is done by using spacing between the grid points of the calibration.

The present invention and calibration method can be generally decomposed in a few key steps that can be applied to cameras, displays or projectors imaging systems. In a first time, images are generated that will be displayed on displays in use in the calibration. These images are used to encode the pixel row and column of the display in the images of a camera. The goal is to obtain a complete or partial map of the position of display pixels within the images of a camera. This is done by displaying a series of images, that when combined and analyzed, allow the calibration software to retrieve the pixel positions, including row and column number, of the display pixels within the images of a camera. This can be done for each channel of the display and each channel of the camera. These sequences are then run by alternating the display of an image and the acquisition of the displayed image using a camera. The images are decoded by decoding the signal, similar to structured light devices.

The corrections can be applied to images at different stages of the image processing pipeline. The camera corrections may be applied to data being processed within the image data processing unit of a camera, before being passed to further computation units. It may also be applied by an external computer, which can apply the correction to the output of the camera data. An image originating from a camera that is saved as data can alternately be processed later. The camera corrections can be applied at any stage of the image processing pipeline. The display and projector correction may be applied within the image data processing unit of a display or projector. The display and projector correction may also be applied to images before being passed to the display. It may be done before a computing unit sends an image, by the computing unit, or may be applied to images before being selected by a computing unit and passed to the display unit. In the case of cameras, the sensor of the camera acquires the photons that will compose an image during an integration time, once the time is elapsed, the values of the pixels from the sensors are organized in a data format that will be transformed into an image at some stage of the image data pipeline. This data can be directly processed and corrected while still within the computing logic of the camera memory or buffer. It can also be processed once the data is transferred to a storage or external processing unit. For a display, the correction can be applied as long as the image being displayed has been corrected, which could be at any stage of the image pipeline.

The present invention is applied through a calibration method that is accessed using a software program on a computer. The user of the software provides information about three functions for any imaging device. These three functions are the initialization function, the image function and a disconnect function. These 3 functions are black boxes from which the software is allowed to pass inputs and collect outputs. The first function has the role of making an initial connection and setting the current calibration parameters of the imaging device, as well as outputting the device object variable, which will be used to further call the other functions. The current calibration parameters may include camera parameters such as exposure, gamma, integration times or any available parameter affecting the images taken by the camera, as well as the values to be set pertaining to the focal position, zoom position or other calibrated parameter. The same is true for displays and projectors, but their parameters may differ. The second function, the image function, is used to acquire an image if the device is a camera, or change the calibration pattern image if a display or projector. The display and camera pair are each called in succession to pass all the calibration images on the display and acquire the images using the camera. Finally, the last function is used to disconnect and release the imaging hardware from the software control.

Once the acquisition is done, the calibration of either the camera or display is done, depending on the need of the user. The software is able to retrieve every pixel location of a display in the camera images. If the display is a regular flat monitor, it is possible to use it as a reference surface for camera calibration, which will be used to later correct non-regular displays or projectors. Knowing all the display pixel positions in the camera images, at each zoom position or focal position, allows the software to correct fully the geometric distortions, the chromatic aberrations and decentering of images. In the first time, a camera is calibrated using a flat monitor for which it is assumed the flatness and pixel spacing is of high enough quality. Once the first camera is corrected, it is used as a reference since it will no longer suffer from optical distortions. The reference is such that it performs like a model pinhole camera model, for which the pixel positions, luminance and directions are fully known. In a second time, displays and projectors can be corrected using the reference camera.

In some embodiments, the image calibrations are applied to an image or a feed of images acquired using the image capture device.

In some embodiments, the image calibrations are applied to an image or a feed of images to be displayed using the image display device.

The present invention has a large number of possible commercial applications. The present invention as a method for correcting imaging systems could be applied to any camera, display or projector, whether monochromatic (singular color) or polychromatic (multiple color channels) and regardless of the optical elements in front of the camera sensor or display and projector outputs. The resulting corrections would allow optical system and imaging system designers to reduce the number of lens elements, change the manufacturing or materials to reduce cost and even enable new applications.

The present invention as a method for correcting imaging systems could be applied to enable calibration and precise measurement of geometry and depth perception across various combinations of multi-projector, multi-camera, and multi-display systems. It ensures seamless alignment and uniformity of multi-source images, measures relative positions, calibrates systems, and reconstructs 3D scenes from an array of devices. Additionally, it corrects for parallax and optimizes visual information overlay, making it applicable to systems involving stereoscopic cameras, laser triangulation, 3D profilers using structured light, binocular displays, Virtual Reality (VR) headsets, Augmented Reality (AR) glasses, eye-tracking for gaze-based interfaces and gesture tracking interfaces used for image synchronization and coordination.

The present invention can be used to measure the relative positions between cameras, displays and projector systems in any combinations and as such, can be used to calibrate and measure the geometry of such systems. The systems may include stereoscopic cameras, 3D profilers using structured light, binocular displays or others.

For example, the newest phone cameras and VR/AR systems now offer large field of view optics, which require good and bulkier optical elements to render appealing images. These images increase in aberrations as the field of view, zoom or focus capabilities are increased. To correct for this, manufacturers are required to spend more on optical elements and plan more space for the optical elements themselves.

The proposed method would allow for a reduction in size and increase in performance for field of view, zoom and focus capabilities, while diminishing cost, which is a great prospect for such a competitive industry. Furthermore, imaging systems also may have immersion requirements and correcting to a perfect optical system would improve immersion of such systems. As freeform optics are taking place in the industry, the present method offers a method that enables the correction of any freeform optic, which is not possible with current methods. For extreme zoom and magnification optics, for applications such as targeting, keeping the center of a crosshair fixed in the image is of most importance, and the present invention is able to provide a correction that would keep the center of the crosshair fixed, while also correcting geometric and chromatic effects. Image recognition would also benefit from the present invention, as correcting to a perfect projection of an image would allow image recognition or machine learning algorithms to operate on rectified images, which would lead to a greater recognition rate.

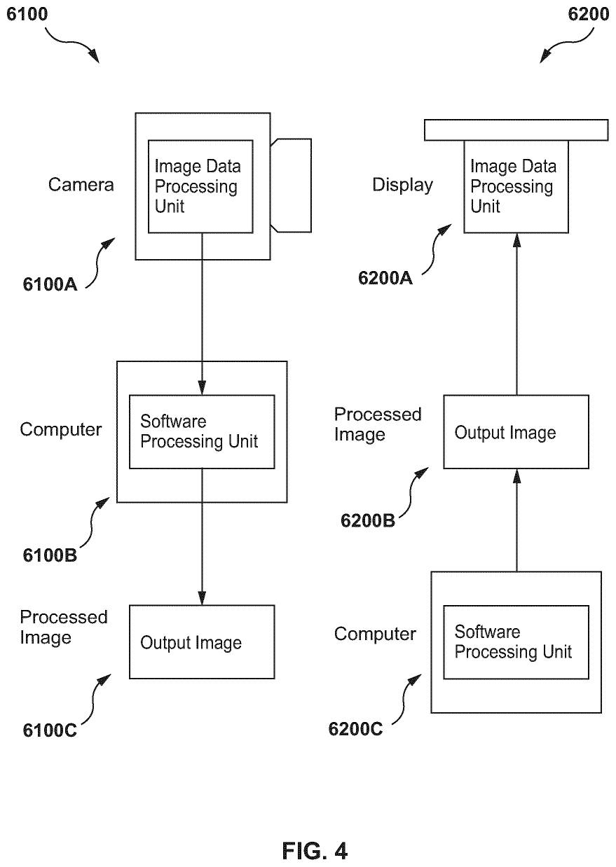

This is crucial for applications such as self-driving or industrial cameras. FIG. 4 describes the different stages at which imaging corrections may be implemented. In the case of the correction of a camera (left) 6100 and display or projector 6200 imaging system (right). The camera corrections may be applied 6100A to data being processed within the image data processing unit of a camera, before being passed to further computation units. It may also be applied 6100B by an external computer, which can apply the correction to the output of the camera data. An image saved as data can alternately be processed later 61000. The camera corrections can be applied at any stage of the image processing pipeline. The display and projector correction 6200 may be applied within the image data processing unit of a display or projector 6200A. The display and projector correction may also be applied to images before being passed to the display. It may be done before a computing unit sends 62000 an image, by the computing unit, or may be applied 6200B to images before being selected by a computing unit and passed to the display unit.

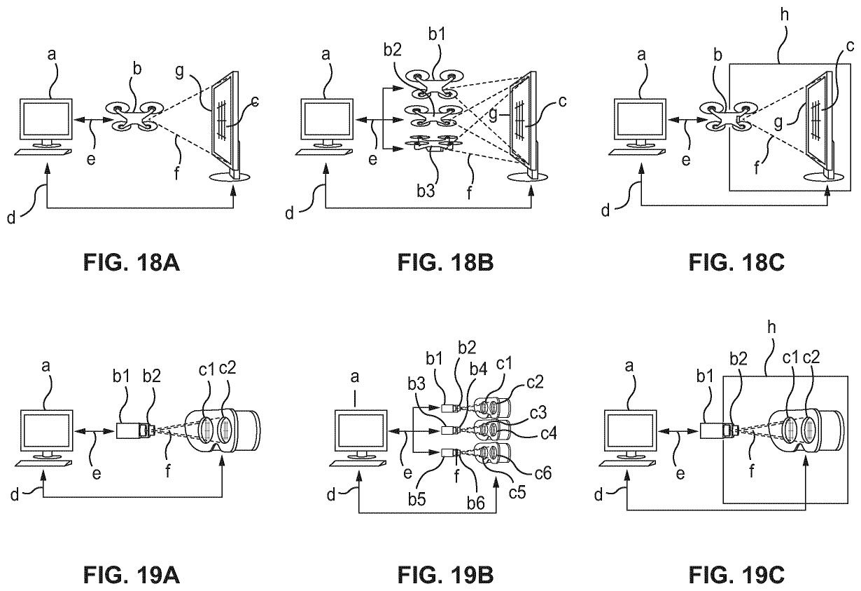

FIGS. 18A-C show a drone camera calibration system, a multiple drone camera calibration system, and drone camera calibration system in a darkroom station, respectively.

The device to calibrate in this illustration is a camera onboard an unmanned aerial or underwater or ground vehicle also called drone. The software on a computer (a) generates encoded images with embedded pixel information, displays these images (g) in sequences on a connected (d) monitor (c) and captures them with a connected (e) drone camera which field of view (f) aligns tightly with the display of the monitor. The software then decodes the pixel information from the recorded images, computes new corrected pixel coordinates for the drone camera and stores them. An internal processor of the drone camera or an external one may be used to automatically apply these pixel corrections or calibrations.

The processes for multiple drone camera calibration are identical to those of the single drone camera calibration except that multiple drone cameras (b1, b2,b3) are calibrated simultaneously. Please note that these drones can also be calibrated sequentially.

The processes for single drone camera calibration in a darkroom are identical to those of the drone camera calibration except that the camera (b) and the monitor (c) are placed inside a darkroom station (h) to avoid external interferences.

The processes described herein may be used to calibrate any one of a camera, a doorbell camera, a mobile phone camera, a tablet camera, a telescope, a microscope, an endoscope, and a vehicle camera.

FIGS. 19A-C show a VR headset display calibration system, a multiple VR headset display calibration system, and a VR headset display calibration system in a darkroom station, respectively.

The device to calibrate in this illustration is a pair of eye socket displays embedded in a virtual reality (VR) headset. The software on a computer (a) generates encoded images with embedded pixel information, displays these images in sequences on a pair of connected (e) eye socket displays (c1, c2) and captures them with a connected (b) pair of cameras (b1, b2), one camera field of view (f) aligns tightly with one eye socket display and the second camera aligns with the second eye socket display. The software than decodes the pixel information from the recorded images, computes new corrected pixel coordinates for each eye socket display and stores them. An internal processor of the VR headset or an external one may be used to automatically apply these pixel corrections or calibrations to each eye socket display.

The processes for a multiple headset display calibration are identical to the processes for the single headset display calibration except that multiple VR headset displays (c1, c2, c3, c4, c5, c6) are calibrated simultaneously.

The processes for headset display calibration in a darkroom are identical to the processes for the headset display calibration except that the VR headset (c1, c2) and the cameras (b1, b2) are placed inside a darkroom station to avoid external interferences.

The processes described herein may be used to calibrate a projector, a monitor or an image display device. Examples of image display devices such as a Virtual Reality (VR) headset display, an Augmented Reality (AR) glass display, etc.

Other examples of implementations will become apparent to the reader in view of the teachings of the present description and as such, will not be further described here.

Note that titles or subtitles may be used throughout the present disclosure for convenience of a reader, but in no way these should limit the scope of the invention. Moreover, certain theories may be proposed and disclosed herein; however, in no way they, whether they are right or wrong, should limit the scope of the invention so long as the invention is practiced according to the present disclosure without regard for any particular theory or scheme of action.

All references cited throughout the specification are hereby incorporated by reference in their entirety for all purposes.

Reference throughout the specification to “some embodiments”, and so forth, means that a particular element (e.g., feature, structure, and/or characteristic) described in connection with the invention is included in at least one embodiment described herein, and may or may not be present in other embodiments. In addition, it is to be understood that the described inventive features may be combined in any suitable manner in the various embodiments.

It will be understood by those of skill in the art that throughout the present specification, the term “a” used before a term encompasses embodiments containing one or more to what the term refers. It will also be understood by those of skill in the art that throughout the present specification, the term “comprising”, which is synonymous with “including,” “containing,” or “characterized by,” is inclusive or open-ended and does not exclude additional, un-recited elements or method steps.

Unless otherwise defined, all technical and scientific terms used herein have the same meaning as commonly understood by one of ordinary skill in the art to which this invention pertains. In the case of conflict, the present document, including definitions will control.

As used in the present disclosure, the terms “around”, “about” or “approximately” shall generally mean within the error margin generally accepted in the art. Hence, numerical quantities given herein generally include such error margin such that the terms “around”, “about” or “approximately” can be inferred if not expressly stated.

Although various embodiments of the disclosure have been described and illustrated, it will be apparent to those skilled in the art considering the present description that numerous modifications and variations can be made. The scope of the invention is defined more particularly in the appended claims.

1. A calibration method for an imaging system comprising an image-forming optical system between an image display device and an image capture device, the method comprising:
determining a mapping function that associates a plurality of image display pixels (k,l) of the image display device with a corresponding plurality of image capture pixels (i,j) of the image capture device;
using a predetermined camera model to approximate the image-forming optical system, determining an ideal image capture pixel (i′,j′) for one or more of the plurality of image display pixels (k,l); and
determining a correction function by reducing an error measure between the ideal image capture pixel (i′,j′) and the corresponding image capture pixel (i,j) of the one or more of the plurality of image display pixels (k,l), the correction function associating the one or more image capture pixels (i,j) with one or more corrected image capture pixels (i_{c},j_{c}).

2. The image calibration method of claim 1, wherein determining a mapping function that associates a plurality of image display pixels (k,l) of the image display device with a corresponding plurality of image capture pixels (i,j) of the image capture device comprises:
displaying a set of encoded images on the display device, the set of encoded images comprising pixel information that allows identification of image display pixels (k,l) when the encoded images are captured by the image capture device;
acquiring each displayed image using the image capture device; and
for each image capture pixel (i,j), identifying the corresponding image display pixel (k,l) using pixel information in the acquired images.

3. The image calibration method of claim 1, wherein determining a mapping function that associates a plurality of image display pixels (k,l) with a corresponding plurality of image capture pixels (i,j) further comprises generating the set of encoded images.

4. The image calibration method of claim 1, wherein determining an ideal image capture pixel (i′,j′) for one or more of the plurality of image display pixels (k,l) further comprises:
determining ideal image display space coordinates
$${[ x , y , z ]}_{k , l}^{d}$$
of the plurality of image display pixels (k,l); and
determining ideal image capture space coordinates
$${[ x , y , z ]}_{i , j}^{c}$$
of the plurality of image capture pixels (i,j), wherein the ideal image display and the ideal image capture space coordinates indicate 3D positional information of the ideal image display and the ideal image capture pixels, respectively.

5. The image calibration method of claim 4, wherein the ideal image display space coordinates
$${[ x , y , z ]}_{k , l}^{d}$$
are determined using initialized image display space coordinates
$${[ {x}_{0} , {y}_{0} , {z}_{0} ]}_{k , l}^{d}$$
given by
$${( {[ {x}_{0} , {y}_{0} , {z}_{0} ]}_{k , l}^{d} )}^{T} = [ {Δ}_{x - d} * ( l - {l}_{o} ) ; {Δ}_{y - d} * ( k - {k}_{O} ) ; 0 ]$$
with:
Δ_{x-d} being an image display pixel column width size,
Δ_{y-d} being an image display pixel row height size,
k_{O} being a display origin pixel row,
l_{O} being a display origin pixel column,
k being an image display pixel row index, and
l being an image display pixel column index;
and wherein the ideal image capture space coordinates
$${[ x , y , z ]}_{i , j}^{c}$$
are determined using initialized image capture space coordinates
$${[ {x}_{0} , {y}_{0} , {z}_{0} ]}_{i , j}^{c}$$
given by
$${( {[ {x}_{0} , {y}_{0} , {z}_{0} ]}_{i , j}^{c} )}^{T} = [ {Δ}_{x - c} * ( j - {j}_{O} ) ; {Δ}_{y - c} * ( i - {i}_{O} ) ; 0 ) ]$$
with:
Δ_{x-c} being an image capture pixel column width size,
Δ_{y-c} being an image capture pixel row height size,
i_{O} being a camera origin pixel row,
j_{O} being a camera origin pixel column,
i being an image capture pixel row index, and
j being an image capture pixel column index.

6. The image calibration method of claim 1, wherein the predetermined camera model is a pinhole model and wherein determining an ideal image capture pixel (i′,j′) for one or more of the plurality of image display pixels (k,l) comprises:
for each image display pixel (k,l), determining a line equation of a line that traverses a focal point of the image-forming optical system and the image display pixel (k,l); and
determining an intersection between the line and an imaging plane of the image forming optical system, the intersection being the ideal image capture pixel (i′,j′).

7. The image calibration method of claim 1, wherein the predetermined camera model is a fisheye model and wherein determining an ideal image capture pixel (i′,j′) for one or more of the plurality of image display pixels (k,l) comprises:
for each image display pixel (k,l), determining a line equation of a line that traverses a focal point of the image-forming optical system and the image display pixel (k,l); and
determining an intersection between the line and an imaging sphere, the intersection being the ideal image capture pixel (i′,j′).

8. The image calibration method of claim 1, wherein the correction function is limited to rotations and/or translations of the image display pixels (k,l) and/or the image capture pixels (i,j) and wherein reducing the error measure is performed by varying angles of the rotations and/or distances of the translations.

9. The image calibration method of claim 1, wherein the method is used for calibrating one or more image capture device channels and/or image display channels by applying the steps of the method to the one or more color channels.

10. The image calibration method of claim 1, wherein the method is used for calibrating one or more image capture device channels, and wherein once the method is applied to a first channel, the method further comprises, for each subsequent channel of the one or more channels:
determining a subsequent channel mapping function that associates a plurality of image display pixels (k,l)_{sc} of the subsequent channel with a corresponding plurality of image capture pixels (i,j)_{sc} of the subsequent channel, so that each image display pixel (k,l) is associated with a first image capture pixel (i,j)ₘ from the first channel and a second image capture pixel (i,j)_{sc} from the subsequent channel, and
determining a subsequent channel correction function that is the sum between the correction function determined for the first channel and a displacement vector, the displacement vector being a vector that extends from the second image capture pixel to the first image capture pixel.

11. The image calibration method of claim 10, further comprising:
applying the correction function to one or more image capture pixels (i,j)ₘ of the first channel to obtain corrected image capture pixels (i_{c},j_{c})ₘ for the first channel; and/or
applying the subsequent channel correction function to one or more image capture pixels (i,j)_{sc} of the second channel to obtain corrected image capture pixels (i_{c},j_{c})_{sc} for the second channel.

12. The image calibration method of claim 1, wherein the method is used for calibrating one or more image display device channels, and wherein once the method is applied to a first channel, the method further comprises, for each subsequent channel of the one or more channels:
determining a subsequent channel mapping function that associates a plurality of image display pixels (i,j) of the subsequent channel with a corresponding plurality of image capture pixels (k,l) of the subsequent channel, so that each image capture pixel is associated with a first image display pixel from the first channel and a second image display pixel from the subsequent channel, and
determining a subsequent channel correction function that is the sum between the correction function determined for the first channel and a displacement vector, the displacement vector being a vector that extends from the second image display pixel to the first image display pixel.

13. The image calibration method of claim 12, further comprising:
applying the correction function to one or more image display pixels (k,l)ₘ of the first channel to obtain corrected image display pixels (k_{c},l_{c})ₘ for the first channel; and/or
applying the subsequent channel correction function to one or more image display pixels (k,l)_{sc} of the second channel to obtain corrected image display pixels (k_{c},l_{c})_{sc} for the second channel.

14. The image calibration method of claim 1, wherein the method is used for calibrating a multi-parameter image capture device, the method comprising:
having corrected pixels determined for a plurality of camera multi-parameter configurations, and a multi-parameter configuration associated with a new image capture device configuration:
interpolating the corrected pixels determined for the plurality of image capture device multi-parameter configurations to obtain corrected pixels associated with the new image capture device configuration.

15. (canceled)

16. The image calibration method of claim 1, wherein when the method is used for calibrating a focusing image capture device, and wherein once the method is applied to a first focal position f_{p-c} of the focusing image capture device, the method further comprises, for each subsequent focal position f_{s-c}:
determining a subsequent mapping function that associates a plurality of image display pixels (k,l)ₛ of the subsequent focal position with a corresponding plurality of image capture pixels (i,j)ₛ of the subsequent focal position f_{s-c}, so that each image display pixel (k,l) is associated with a first image capture pixel (i,j)ₚ from the first focal position and a second image capture pixel (i,j)ₛ from the subsequent focal position; and
determining a subsequent correction function that is the sum between the correction function determined for the first focal position and a displacement vector, the displacement vector being a vector that extends from the second image capture pixel to the first image capture pixel.

17. The image calibration method of claim 16, wherein the method is used for calibrating one or more channels of a focusing image capture device, and wherein once the method is applied to a first channel of each focal position fₚ of the focusing image capture device, the method further comprises, for each subsequent channel of each focal position:
determining a subsequent channel mapping function that associates a plurality of image display pixels (k,l)_{sc} of the subsequent channel with a corresponding plurality of image capture pixels (i,j)_{sc} of the subsequent channel, so that each image display pixel (k,l) is associated with a first image capture pixel (i,j)ₘ from the first channel and a second image capture pixel (i,j)_{sc} from the subsequent channel, and
determining a subsequent channel correction function that is the sum between the subsequent channel correction function determined for the first channel and a displacement vector, the displacement vector being a vector that extends from the second image capture pixel to the first image capture pixel.

18. The image calibration method of claim 1, wherein when the method is used for calibrating a focusing image display device, and wherein once the method is applied to a first focal position f_{p-d} of the focusing image display device, the method further comprises, for each subsequent focal position f_{s-d}:
determining a subsequent mapping function that associates a plurality of image display pixels (k,l)ₛ of the subsequent focal position with a corresponding plurality of image capture pixels (i,j)ₛ of the subsequent focal position f_{s-d}, so that each image capture pixel (i,j) is associated with a first image display pixel (k,l)ₚ from the first focal position f_{p-d} and a second image display pixel (k,l)ₛ from the subsequent focal position f_{s-d}; and
determining a subsequent correction function that is the sum between the correction function determined for the first focal position and a displacement vector, the displacement vector being a vector that extends from the second image display pixel to the first image display pixel.

19. The image calibration method of claim 17, wherein the method is used for calibrating one or more channels of a focusing image display device, and wherein once the method is applied to a first channel of each focal position of the focusing image display device, the method further comprises, for each subsequent channel of each focal position:
determining a subsequent channel mapping function that associates a plurality of image display pixels (k,l)_{sc} of the subsequent channel with a corresponding plurality of image capture pixels (i,j)_{sc} of the subsequent channel, so that each image capture pixel (i,j) is associated with a first image display pixel (k,l)ₘ from the first channel and a second image display pixel (k,l)_{sc} from the subsequent channel, and
determining a subsequent channel correction function that is the sum between the subsequent channel correction function determined for the first channel and a displacement vector, the displacement vector being a vector that extends from the second image display pixel to the first image display pixel.

20. The image calibration method of claim 1, wherein when the method is used for calibrating a zooming image capture device, the method comprises performing the method of claim 1 for each desired zoom position.

21. The image calibration method of claim 1, wherein when the method is used for calibrating one or more channels of a zooming image capture device, and wherein once the method is performed for first channel of each desired zoom position, the method further comprises, for each subsequent channel of each desired zoom position:
determining a subsequent channel mapping function that associates a plurality of image display pixels (k,l)_{sc} of the subsequent channel with a corresponding plurality of image capture pixels (i,j)_{sc} of the subsequent channel, so that each image display pixel (k,l) is associated with a first image capture pixel (i,j)ₘ from the first channel and a second image capture pixel (i,j)_{sc} from the subsequent channel, and
determining a subsequent channel correction function for the subsequent channel, the subsequent channel correction function being a sum between the correction function determined for the first channel and a displacement vector, the displacement vector being a vector that extends from the second image capture pixel to the first image capture pixel.

22. The image calibration method of claim 1, wherein the plurality of pixels represents a subset of all pixels of an image, and wherein corrected pixels of remaining image pixels are obtained by interpolating adjacent corrected pixels.

23-33. (canceled)

34. An image calibration system for calibrating an imaging system comprising an image-forming optical system between an image display device and an image capture device, wherein the image calibration system comprises:
one or more computer processors;
one or more computer readable storage media for storing computer-implemented instructions, wherein the one or more computer processors are configured to execute the computer-implemented instructions to cause the computer system to perform the method of claim 1.

35-66. (canceled)

67. A non-transitory computer program product comprising computer-implemented instructions to cause a computer system to execute the method of claim 1.

68. (canceled)
